(19) United States
(12) Patent Application Publication
(10) Pub. No.: US 2016/0171472 A1
(43) Pub. Date: Jun. 16, 2016

(54) SYSTEM AND METHOD FOR IDENTIFYING MEMBER CUSTOMERS OF A RETAIL ENTERPRISE MEMBERSHIP SERVICE AT ENTERPRISE POINT-OF-SALE SYSTEMS

(71) Applicant: Meijer, Inc., Grand Rapids, MI (US)

(72) Inventors: Brian Pugh, Grand Rapids, MI (US); Elmer L. Robinson, Jr., Marne, MI (US); David Scott Pallas, Hudsonville, MI (US); K. Michael Ross, Grand Rapids, MI (US)

(21) Appl. No.: 14/965,874

(22) Filed: Dec. 10, 2015

Related U.S. Application Data
(60) Provisional application No. 62/090,260, filed on Dec. 10, 2014.

(51) Int. Cl. G06Q 20/20; G06Q 20/38; G06Q 20/40; G06Q 20/32

(52) U.S. Cl. CPC G06Q 20/204; G06Q 20/327; G06Q 20/208; G06Q 20/387; G06Q 20/401

(57) ABSTRACT

Disclosed is a system and method for effecting payment for purchases at point-of-sale systems of a retail enterprise. Each point-of-sale system is associated with a different stored identification code, and a stored first code is associated with a stored electronic payment system preauthorized by a customer member of the retail enterprise for automatic payment processing during purchase transactions carried out by the customer member at any of the plurality of point-of-sale systems. In response to a wirelessly received identification code, the point-of-sale system associated with the stored identification code that matches the wirelessly received identification code is identified, and in response to a wirelessly received second code, payment for one or more items in a current purchase transaction at the identified point-of-sale system is automatically processed using the stored, preauthorized electronic payment system if the wirelessly received second code matches the stored first code.

### CROSS-REFERENCE TO RELATED APPLICATIONS

This patent application claims the benefit of, and priority to, U.S. Provisional Patent Application Ser. No. 62/090,260, filed Dec. 10, 2014, the disclosure of which is expressly incorporated herein by reference.

### FIELD OF THE INVENTION

The present invention relates generally to systems and methods for effecting payment for and tracking point-of-sale purchases made by shoppers at a retail enterprise, and more specifically to systems and methods for automatically effecting such payment using an instrument of electronic funds transfer and/or for automatically linking such purchases to shopper membership accounts managed by the retail enterprise.

### BACKGROUND

Retailers of goods and services typically offer such goods and services for purchase via one or more conventional brick-and-mortar retail stores. It may be desirable for retailers to offer a shopper membership service program to their customers for the purpose of offering shopping benefits and/or tracking customer purchases over time. It may further be desirable to include in such a shopper membership service program a mechanism via which customers can pre-authorize an instrument of electronic funds transfer which will be automatically processed for payment for subsequent purchases from the retailer, and/or via which such customer purchases can be automatically tracked, in a manner that does not require customers to manually provide payment or shopper membership service identification information at the point-of-sale.

### SUMMARY

The present invention may comprise one or more of the features recited in the attached claims, and/or one or more of the following features and combinations thereof. In one aspect, a method of effecting payment for purchases at any of a plurality of point-of-sale systems of a retail enterprise may comprise associating, with a first processor in a first database, each of the plurality of point-of-sale systems with a different identification code, associating, with the first processor in the first or a second database, a first code and an electronic payment system preauthorized by a customer member of the retail enterprise for automatic payment processing during purchase transactions carried out by the customer member at any of the plurality of point-of-sale systems, in response to a wirelessly received identification code, identifying with the first processor the one of the plurality of point-of-sale systems associated in the first database with the identification code that matches the wirelessly received identification code, and in response to a wirelessly received second code, automatically processing with the first processor payment for one or more items in a current purchase transaction at the identified one of the plurality of point-of-sale systems using the preauthorized electronic payment system if the wirelessly received second code matches the first code.

### BRIEF DESCRIPTION OF THE DRAWINGS

This disclosure is illustrated by way of example and not by way of limitation in the accompanying figures. Where considered appropriate, reference labels have been repeated among the figures to indicate corresponding or analogous elements.

FIG. 1 is a simplified block diagram of an embodiment of a system for identifying member customers of a retail enterprise membership service at enterprise point-of-sale systems and for processing payment for purchase transactions made by the identified customer according to the identified customer's pre-established payment preferences.

FIG. 2 is a simplified block diagram of an embodiment of one of the point-of-sale systems illustrated in FIG. 1.

FIG. 3A is a simplified block diagram of an embodiment of one of the mobile communication devices illustrated in FIG. 1.

FIG. 3B is a simplified block diagram of an embodiment of one of the user computing devices illustrated in FIG. 1.

FIG. 4 is a simplified block diagram of an embodiment of a software environment of the main server of FIG. 1.

FIG. 5 is a simplified flow diagram of an embodiment of a process for facilitating entry by a customer into the customer's enterprise membership account of electronic payment information for an electronic payment system that the customer authorizes the retail enterprise to automatically process in future transactions as payment for the purchase via a point-of-sale system of one or more items from the retail enterprise.

FIG. 6A is a simplified flow diagram of an embodiment of the MIP code generation process executed as part of the process illustrated in the flow diagram of FIG. 5.

FIG. 6B is a simplified flow diagram of another embodiment of the MIP code generation process executed as part of the process illustrated in the flow diagram of FIG. 5.

FIG. 7 is a simplified flow diagram of an embodiment of a process for determining, during a transaction for the purchase of one or more items at one of the point-of-sale systems of the retail enterprise, payment preferences pre-established by the customer, and for processing payment for the purchase transaction in accordance with the customer's pre-established payment preferences.

FIG. 8 is a simplified flow diagram of an embodiment of the MIP process executed as part of the process illustrated in the flow diagram of FIG. 7.

FIG. 9 is a simplified diagram illustrating an embodiment of a communications framework for detecting by a mobile communication device of wireless signals produced by a wireless signal broadcasting device associated with a point-of-sale system and for conducting wireless communications relating thereto between the mobile communication device and the main server of the retail enterprise.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure, process, process step or characteristic is described in connection with an embodiment, it is submitted that it is within the knowledge of one skilled in the art to effect such feature, structure, process, process step or characteristic in connection with other embodiments whether or not explicitly described. Further still, it is contemplated that any single feature, structure, process, process step or characteristic disclosed herein may be combined with any one or more other disclosed feature, structure, process, process step or characteristic, whether or not explicitly described, and that no limitations on the types and/or number of such combinations should therefore be inferred.

Embodiments of the invention may be implemented in hardware, firmware, software, or any combination thereof. Embodiments of the invention implemented in a computer system may include one or more bus-based interconnects between components and/or one or more point-to-point interconnects between components. Embodiments of the invention may also be implemented as instructions stored on one or more machine-readable media, which may be read and executed by one or more processors. A machine-readable medium may be embodied as any device or physical structure for storing or transmitting information in a form readable by a machine (e.g., a computing device). For example, a machine-readable medium may be embodied as any one or combination of read only memory (ROM); random access memory (RAM); magnetic disk storage media; optical storage media; flash memory devices; and others.

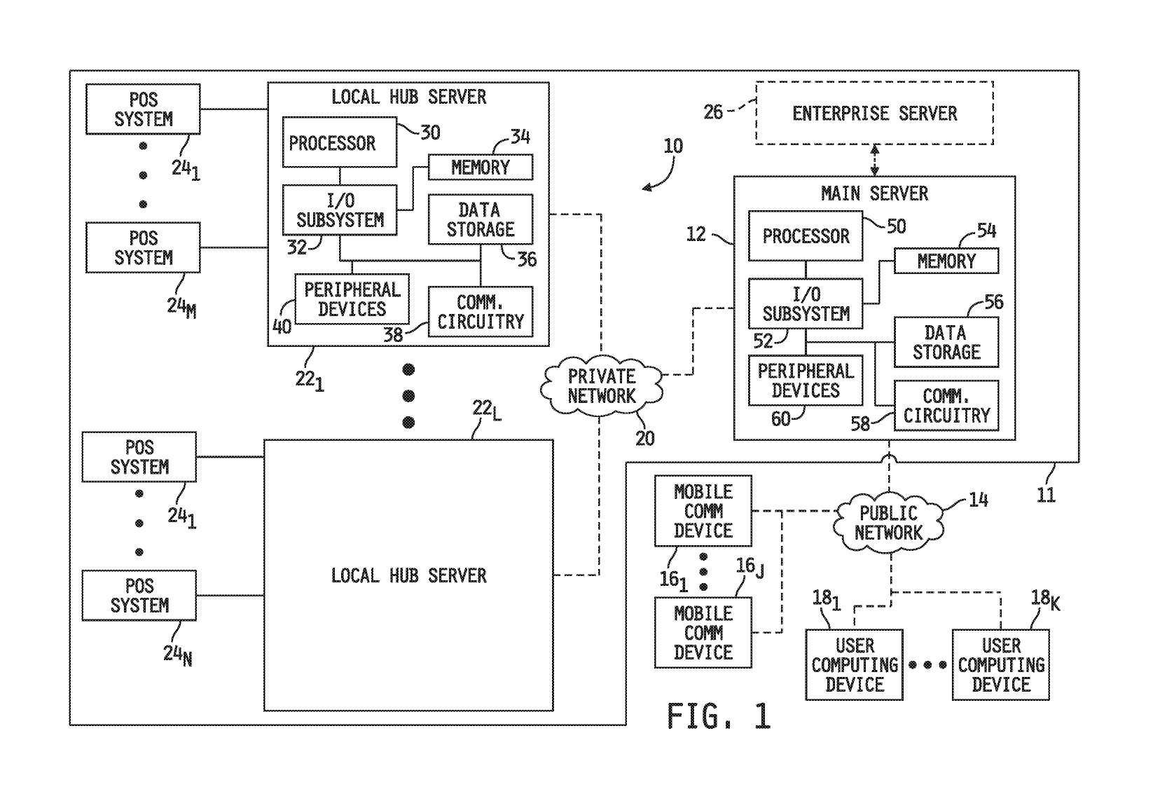

Referring now to FIG. 1, a system 10 is shown for identifying member customers of a retail enterprise membership service at enterprise point-of-sale systems and for processing payment for purchase transactions made by the identified customer according to the identified customer's pre-established payment preferences. The system 10 includes a retail enterprise 11 having a main server 12 configured to communicate with shoppers via a public network 14, e.g., the Internet, and shoppers may access the public network 14 using any conventional public network accessible electronic device and/or system. In the illustrated embodiment, for example a number, J, of mobile communication devices 16₁-16_{J}, and a number, K, of user computing devices 18₁-18_{K}, are shown. Each is configured to communicatively connect to the public network 14, and J and K may each be any positive integer. The retail enterprise 11 may include any number of brick-and-mortar retail outlets each having one or more point-of-sale systems 24₁-24_{M}, 24₁-24_{N} operating therein. The main server 12 is configured to communicate with each such point-of-sale (POS) system 24₁-24_{M}, 24₁-24_{N}, each of which operate in a conventional manner to process items to be purchased by shoppers during purchase transactions.

In some embodiments, the main server 12 illustratively hosts an enterprise member or membership services (EMS) program which includes or otherwise has access to a virtual coupon bank and a customer purchase history database containing purchase histories of one or more customers of the retail enterprise 11. As used herein, the term “enterprise member services program,” “enterprise membership services program” or EMS and “shopper membership service” are interchangeable and refer to a shopper or customer service which may offer to customer members one or more services such as making available to customers one or more virtual discount coupons that may be redeemable by the retail enterprise against the purchase of from the retail enterprise of various goods and/or services and/or tracking and maintaining customer purchase histories in a customer purchase history database accessible by the main server 12. In this regard, the terms “shopper membership account” and “EMS account” are likewise interchangeable and refer to a mechanism by which the retail enterprise 11 may make available to customers one or more virtual discount coupons and/or by which a customer's purchase history and information about the customer can be maintained by the main server 12 in a database separately from purchase histories of and information about other customers. Further in this regard, the term “EMS identification code” or EMSID illustratively refers to at least one collection of letters, symbols and/or numbers that is different for, and therefore unique to, each customer member of the enterprise membership services program, and which is used to uniquely identify a customer's EMS account within the enterprise membership services program. In one embodiment, for example, the EMSID for each customer may include a unique, several-digit access code and a separate and unique, several-digit password, although in other embodiments the EMSID may include more, fewer and/or different codes and/or passwords.

As will be discussed in further detail below, the main server 12 illustratively includes an EMS module that manages and controls a customer-member interface, e.g., a web-based interface, to the EMS program via which customers can access and manage their individual EMS accounts. Illustratively, each customer may access their individual (and private from other customer-members) EMS account, i.e., their individual EMS page(s) within the web-based EMS interface, which may be referred to hereinafter as an “EMS website,” by entering that customer's EMSID into a graphic user interface element of the web-based EMS interface. Therein, the customer may access, establish, modify and otherwise manage the customer's EMS account information including, for example, but not limited to, name, address, email address, mobile telephone number and, as will be described in greater detail below, electronic payment information (EPI) associated with one or more forms of electronic payment.

In the embodiment illustrated in FIG. 1, the main server 12 is coupled via a private network 20 to a plurality of local hub servers 22₁-22_{L}, where L may be any positive integer, and each local hub server 22₁-22_{L} is coupled to one or more conventional point-of-sale systems, e.g., 24₁-24_{M}, 24₁-24_{N}. Each of the point-of-sale systems 24₁-24_{M}, 24₁-24_{N} is configured to process items selected by customers for purchase and to process payment for such items. Some retail enterprises may include a single brick and mortar outlet, and other larger enterprises may include two or more physically remote brick and mortar outlets. In the latter case, the retail enterprise may include, for example, a main physical location with two or more remote physical locations, and for purposes of this document the two or remote physical locations in such an arrangement are referred to as “hub” locations. In this disclosure, the system 10 will be illustrated and described in the context of such a larger retail enterprise having a main physical location and two or more physical hub locations. In this regard, the main server 12 in the system 10 shown in FIG. 1 will typically be located at a main business location of the retail enterprise, and will be coupled via the network 20 to two or more local hub servers 22₁-22_{L}, each of which will typically be located at a different one of the two or more hub locations.

Each hub location may include any number of point-of-sale systems coupled to a corresponding local hub server, and in the embodiment illustrated in FIG. 1, for example, the local hub server 22₁ is communicatively coupled to “M” such point-of-sale systems 24₁-24_{M}, where M may be any positive integer, and the local hub server 22_{K} is communicatively coupled to “N” such point-of-sale systems 24₁-24_{N}, where N may be any positive integer and where M may or may not be equal to N. Communicative coupling between the local hub server 22₁ and the one or more point-of-sale systems 24₁-24_{M}, and between the local hub server 22_{L} and the one or more point-of-sale systems 22₁-22_{N}, may be accomplished using any known communication coupling, and communications over any such hardwire and/or wireless coupling may be accomplished using any known communication protocol.

In some alternative embodiments of such a large retail enterprise, one or more of the local hub servers 22₁-22_{L} may be omitted, and the main server 12 may be coupled directly, via the network 20, to one or more point-of-sale systems 24₁-24_{M}, 24₁-24_{N}, or the main server 12 may be omitted and at least one of the local hub servers 22₁-22_{L} may be configured to act as a so-called master server with the remaining local hub servers 22₁-22_{L} configured to act as so-called slave servers. In other alternative embodiments in which the retail enterprise includes only a single brick and mortar outlet, the local hub servers 22₁-22_{L} may be or include the main server 12 or vice versa. For purposes of the following description, any process disclosed as being controlled by the main server 12 may, in some embodiments, instead be controlled, in whole or in part, by one or more local hub servers 22₁-22_{L} and vice versa, and/or may be controlled, in whole or in part, by one of the point-of-sale systems 24₁-24_{M}, 24₁-24_{N} and vice versa.

The local hub server 22₁ may be embodied as any type of server (e.g., a web server) or similar computing device capable of performing the functions described herein. In the illustrative embodiment of FIG. 1, the local hub server 22₁ includes a processor 30, an I/O subsystem 32, a memory 34, a data storage 36, a communication circuitry 38, and one or more peripheral devices 40. It should be appreciated that the local hub server 22₁ may include other components, sub-components, and devices commonly found in a server and/or computing device, which are not illustrated in FIG. 1 for clarity of the description.

The processor 30 of the local hub server 22₁ may be embodied as any type of processor capable of executing software/firmware, such as a microprocessor, digital signal processor, microcontroller, or the like. The processor 30 may be a single processor or include multiple processors. The I/O subsystem 32 of the local hub server 22₁ may be embodied as circuitry and/or components to facilitate input/output operations with the processor 30 and/or other components of the local hub server 22₁. The processor 30 is communicatively coupled to the I/O subsystem 32.

The memory 34 of the user local hub server 104 may be embodied as or otherwise include one or more conventional volatile and/or non-volatile memory devices. The memory 34 is communicatively coupled to the I/O subsystem 32 via a number of signal paths. Although only a single memory device 34 is illustrated in FIG. 1, the local hub server 22₁ may include additional memory devices in other embodiments. Various data and software may be stored in the memory 34. The data storage 36 is also communicatively coupled to the I/O subsystem 32 via a number of signal paths, and may be embodied as any type of device or devices configured for the short-term or long-term storage of data such as, for example, memory devices and circuits, memory cards, hard disk drives, solid-state drives, or other data storage devices.

The communication circuitry 38 of the local hub server 22₁ may include any number of devices and circuitry for enabling communications between the local hub sever 22₁ and the main server 12 and between the local hub server 22₁ and the one or more point-of-sale systems 24₁-24_{M}. In the illustrated embodiment, for example, communication between the local hub server 22₁ and the main server 12 takes place wirelessly via the network 20, wherein the network 20 may represent, for example, a private local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). In alternative embodiments, the communication path between the local hub server 22₁ and the main server 12 may be a non-private network and/or may be, in whole or in part, a wired connection. Generally, the communication circuitry 38 may be configured to use any one or more, or combination, of conventional secure and/or unsecure communication protocols to communicate with the main server 12. As such, the network 20 may include any number of additional devices, such as additional computers, routers, and switches, to facilitate communications between the local hub server 22₁ and the main server 12. Communication between the local hub server 22₁ and the one or more point-of-sale systems 24₁-24_{M}, 24₁-24_{N} may take place via one or more such wireless communication interfaces and/or via one or more conventional wired interfaces.

In some embodiments, the local hub server 22₁ may also include one or more peripheral devices 40. Such peripheral devices 40 may include any number of additional input/output devices, interface devices, and/or other peripheral devices. For example, the peripheral devices 40 may include a display, a keyboard, a mouse, audio processing circuitry, and/or other input/output devices.

The local hub server 22_{L} may be substantially similar to the local hub server 22₁ and include similar components. As such, the description provided above of the components of the local hub server 22₁ may be equally applicable to such similar components of the local hub server 22_{L} and are not repeated herein so as not to obscure the present disclosure. Of course, it should be appreciated that in some embodiments one or more of the local hub servers 22₁-22_{L} and may be dissimilar to others of the local hub servers 22₁-22_{L}.

An embodiment of the main server 12 is also illustrated in FIG. 1, and generally includes the same components as the local hub server 22₁. For example, a processor 50 is coupled to an I/O subsystem 52, and the I/O subsystem 52 is coupled to a memory 54, a data storage unit 56, communication circuitry 58 and one or more peripheral devices 60. In some embodiments, each of the foregoing components may be identical to corresponding components of the local hub server 22₁ described above, and a detailed explanation of such components will not be repeated here for brevity. In other embodiments, the main server 12 may be configured differently than the local hub server 22₁ described above. In any case, the communication circuitry 38 of each of the local hub servers 22₁-22_{L} facilitates communication with the communication circuitry 58 of the main server 12 and vice versa so that information can be shared between the main server 12 and each of the one or more local hub servers 22₁-22_{L} via the network 20. Although only one such main server 12 is shown in FIG. 1, it should be appreciated that, in other embodiments, the system 10 may include any number of shopper main servers, and in still other embodiments the main server 12 may be communicatively coupled to one or more remote servers of the retail enterprise, and an example of one such remote enterprise server 26 is shown in FIG. 1. In such embodiments, the one or more remote servers 26 may include any structure or feature illustrated and described herein with respect to the main server 12, and may be configured to execute any one or more functions described with respect to the main server 12 either alternatively to the main server 12 or in addition to the main server 12. In any case, the main server 12 may be embodied as any type of server (e.g., a web server) or similar computing device capable of performing the functions described herein.

The mobile communication devices 16₁-16_{J} illustrated in FIG. 1 are intended to depict mobile communication devices that are each separately owned and/or operated by a different shopper. No limit on the total number of such mobile communication devices 16₁-16_{J} that may be owned and operated by any one shopper, or on the total number of such mobile communication devices 16₁-16_{J} that may communicate with the main server 12, is intended or should be inferred. The mobile communication devices 16₁-16_{J} may be or include any mobile electronic device capable of executing one or more software application programs as described herein and of communicating with the main server 12 via the public network 14. Examples of the mobile communication devices 16₁-16_{J} include, but should not be limited to, mobile telephones, smart phones, tablet computers, personal data assistants (PDAs), and the like.

The user computing devices 18₁-18_{L} illustrated in FIG. 1 are intended to include any of privately owned and accessed computers, such as those residing in shopper's residences, to include semi-privately owned and accessed computers, such as those residing at multiple-employee business enterprises, and publicly accessible computers, such as those available at internet cafés and kiosks. The user computing devices 18₁-18_{L} may be or include any computer capable of executing one or more software programs and of communicating with the main server 12 via the public network 14. Examples of the user computing devices 18₁-18_{L} include, but should not be limited to, personal computers (PCs), laptop computers, notebook computers and the like, whether or not networked with one or more other computing devices.

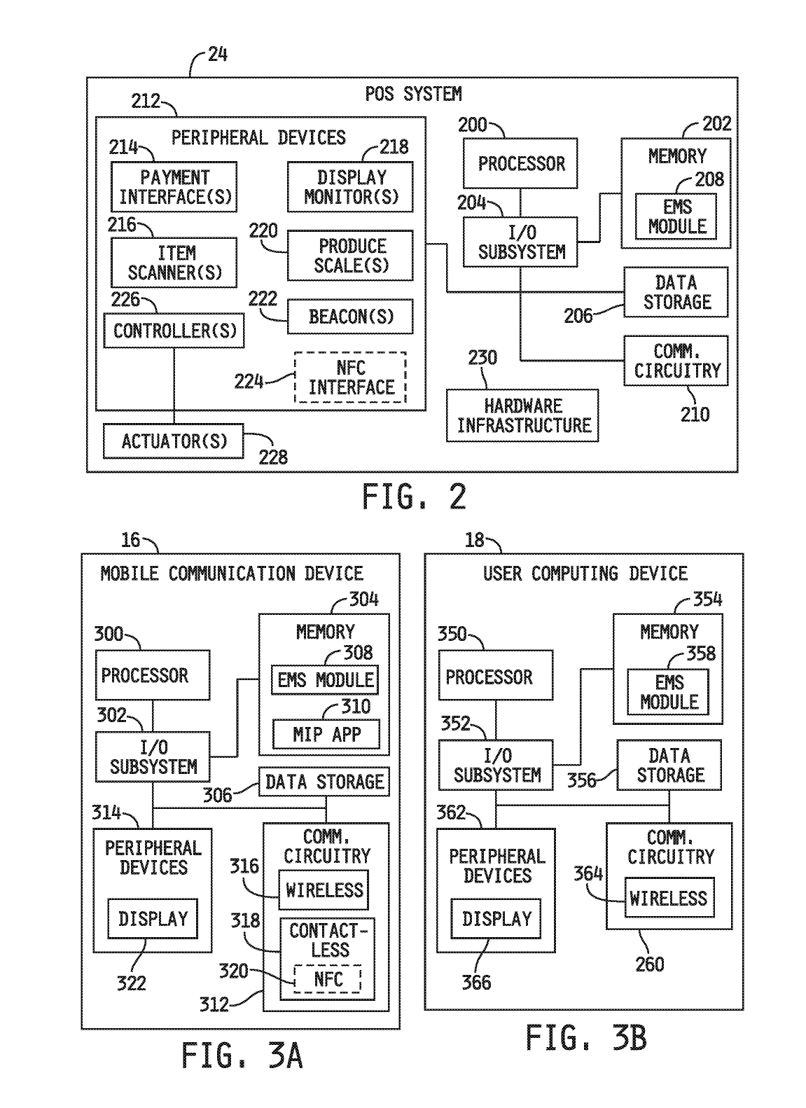

Referring now to FIG. 2, an embodiment 24 of one of the one or more point-of-sale systems, 24₁-24_{M}, 24₁-24_{N}, is shown which includes components similar to the main server 12 and also to the one or more local hub servers 22₁-22_{L}, such as a processor 200, an I/O subsystem 204, a memory 202, a data storage device 206, communication circuitry 210 and a number of peripheral devices 212. In some embodiments, each of the foregoing components may be identical to corresponding components of the local hub server 22₁ described above, and a detailed explanation of such components will not be repeated here for brevity. In other embodiments, any of the one or more point-of-sale systems 24₁-24_{M}, 24₁-24_{N} may be configured differently than the local hub server 22₁ described above. In the illustrated embodiment, the memory 202 illustratively includes an EMS module 208 in the form of, e.g., instructions executable by the processor 200, to communicate customer-member information relating to the customer's EMS account to and from the main server 12, and to control one or more local peripheral devices to facilitate communications between customer-members of the enterprise membership service (EMS) program and the main server 12 and to facilitate manual customer input of customer-identifying information, e.g., an EMS identifying number and/or code (EMSID).

Additionally, the illustrated point-of-sale system 24 includes one or more actuators 226 and hardware infrastructure 228, examples of which will be described below. It will be appreciated that the point-of-sale system 24 may include other components, sub-components, and devices commonly found in a computer and/or computing device. In any case, the communication circuitry 210 is configured to facilitate communication with a corresponding one of the local hub servers 22₁-22_{L} and the point-of-sale system 24 may use any suitable communication protocol to communicate with the corresponding local hub server 22₁-22_{L}.

In addition to, or alternatively to, the number of peripheral devices 40 of the local hub server 22₁ described above, the number of peripheral devices 212 of the point-of-sale system 24 may include any number of other peripheral or interface devices. Examples of some of the peripheral devices 212 illustrated in FIG. 2 include, but should not be limited to, one or more conventional payment interfaces 214, one or more conventional item price scanners 216, one or more conventional display monitors 218, one or more conventional produce scales 220, one or more position identification devices (PIDs) 222, and one or more conventional controllers 226 for controlling one or more conventional actuators 228 associated with the operation of the point-of-sale system 24. The one or more payment interfaces 214 are provided, e.g., to facilitate physical receipt of credit/debit card and/or other form of payment from customers (shoppers), and each such interface 214 may illustratively include one or more of a display, a touch screen, a keyboard, a mouse, external speakers, and/or other peripheral devices. One or more of the payment interfaces 214 may further include a produce scale 220, and one or more produce scales 220 may alternatively be coupled to the point-of-sale system 24 separately from the one or more customer payment interfaces 214. The one or more item scanner(s) 216 is/are configured to scan price code labels or other such indicators for items being purchased by customers and to also scan print media coupons.

The one or more display monitor(s) 218 provide item and/or pricing information to customers and/or enterprise employees, and may further provide additional information regarding cost and/or discounts for one or more items being purchased as well as information regarding discounts realized by customers through the use of print media and/or virtual coupons. The display monitor(s) 218 may additionally provide an interface, e.g., touchscreen or a co-located keypad, via which customers may input information such as their EMSID into the system 10.

The peripheral devices 212 of the point-of-sale system 24 further include at least one position identification device 222. In one embodiment, the position identification devices 222 are illustratively provided in the form of conventional electronic wireless signal broadcasting devices, e.g., conventional radio frequency broadcasting beacons as specifically illustrated in the attached figures, for the purpose of broadcasting radio signals carrying information corresponding to the location and/or identity thereof, and will be described in the remainder of this document as such. It will be understood, however, that this disclosure contemplates other embodiments in which one or more of the position identification devices 222 is/are provided in another form or in one or more other forms. Examples of such other forms will be described at the end of this document.

The at least one wireless signal broadcasting device 222 may be mounted to or near the point-of-sale system 24, and is illustratively configured to periodically broadcast one or more unique wireless identification signals, i.e., one or more identification signals that distinguish the particular wireless signal broadcasting device 222 from wireless signal broadcasting devices 222 associated with others of the point-of-sale systems 24₁-24_{M}, 24₁-24_{N} within the retail enterprise 11. In some alternate embodiments, the at least one wireless signal broadcasting device 222 may be configured to broadcast one or more unique wireless signals non-periodically. In some embodiments, each point-of-sale system 24₁-24_{M}, 24₁-24_{N} has a single wireless signal broadcasting device 222 associated therewith, i.e., located at or near the point-of-sale system. In such embodiments, each point-of-sale wireless signal broadcasting device 222 is illustratively configured to periodically broadcast a unique wireless identification signal that is different from, and which distinguishes the particular wireless signal broadcasting device 222 from, the wireless identification signals broadcast by all other wireless signal broadcasting devices within the retail enterprise 11. In other embodiments, each point-of-sale system 24₁-24_{M}, 24₁-24_{N} may have two or more wireless signal broadcasting devices 222, e.g., a “set” of wireless signal broadcasting devices 222, associated therewith. In such embodiments, each set point-of-sale wireless signal broadcasting devices 222 may illustratively be configured to periodically broadcast a wireless identification signal that is identical to those in the set of wireless signal broadcasting devices but different and distinguishable from the wireless identification signals broadcast by all other wireless signal broadcasting devices within the retail enterprise 11. Alternatively, each set of point-of-sale wireless signal broadcasting devices 222 may be configured to periodically broadcast a wireless identification signal that is different and distinguishable from the wireless identification signals broadcast by those wireless signal broadcasting devices 222 within the set of point-of-sale wireless signal broadcasting devices 222 and that is also different and distinguishable from the wireless identification signals broadcast by all other wireless signal broadcasting devices within the retail enterprise 11.

In some embodiments, the one or more wireless signal broadcasting devices 222 are each configured to periodically broadcast wireless identification signals in the radio frequency (RF) range, although any of the one or more wireless signal broadcasting devices 222 may be configured to alternatively broadcast wireless identification signals in one or more other frequency ranges. In any case, the one or more wireless signal broadcasting devices 222 are further each configured to broadcast wireless identification signals with a predefined broadcast range and/or orientation (i.e., direction). Illustratively, the broadcast range of each wireless signal broadcasting device 222 is sufficiently large, wide and/or oriented to be detected by mobile communication devices 16₁-16_{J} carried by customers during the normal processing by the point-of-sale system 24 of one or more items being purchased, e.g., such processing including receipt, transport, price scanning and/or bagging of purchased items, while is at the same time sufficiently small, narrow and/or oriented so as not to be detected by mobile communication devices 16₁-16_{J} of customers being processed by one or more adjacent point-of-sale systems 24₁-24_{M}, 24₁-24_{N}.

Illustratively, the unique wireless identification signals broadcast by each wireless signal broadcasting device 222 carry decodable information in the form of a unique identification code (UID). Generally, the UID of each wireless signal broadcasting device 222, or in some embodiments each set of wireless signal broadcasting devices 222, uniquely identifies that wireless signal broadcasting device 222 and distinguishes that wireless signal broadcasting device 222 from all other wireless signal broadcasting devices within the retail enterprise 11 or at least within the particular brick-and-mortar store or outlet in or at which the wireless signal broadcasting device 222 is located. In some embodiments, the UID may further include, and/or the unique wireless identification signals broadcast by the one or more wireless signal broadcasting devices 222 may additionally carry, wireless signal broadcasting device type information in the form of a wireless signal broadcasting device type code (BT). Generally, the wireless signal broadcasting device type code, BT, identifies the general location or use of the wireless signal broadcasting device 222 within the retail enterprise 11. Example wireless signal broadcasting device types may include, but should not be limited to, point-of-sale wireless signal broadcasting devices, brick-and-mortar location entrance wireless signal broadcasting devices, wireless signal broadcasting devices associated with specific departments or product category locations within the retail enterprise 11, general store location wireless signal broadcasting devices, or the like. The wireless signal broadcasting device type code, BT, of each wireless signal broadcasting device 222, in embodiments in which include the wireless signal broadcasting device type code, BT, is thus a point-of-sale wireless signal broadcasting device or POS wireless signal broadcasting device. Those skilled in the art will recognize additional and/or alternative information that may be included within or appended to the UID, and/or carried by the unique wireless identification signals broadcast by the one or more wireless signal broadcasting devices 222, and it will be understood that any such additional and/or alternative information is contemplated by this disclosure.

Radio frequency broadcasting beacons 222, as illustrated in FIGS. 2, 8 and 9, represent only one example embodiment of a wireless signal broadcasting device that may be included in the peripheral devices 212 of the point-of-sale system 24 and that may be located at or near one or more of the point-of-sale system 24₁-24_{M} for the purpose of broadcasting one or more unique wireless identification signals. Those skilled in the art will recognize other wireless signal broadcasting devices that may be substituted for one or more of the wireless signal broadcasting devices 222, and it will be understood that any such other wireless signal broadcasting devices are contemplated by this disclosure. Any one or more such alternate wireless signal broadcasting device may be operable to broadcast one or more unique wireless identification signals periodically or non-periodically in any frequency range with any orientation or direction and/or having any broadcast range, and decodable information carried by such one or more unique wireless identification signals may illustratively include, in addition to a unique identification code, UID, a wireless signal broadcasting device type code (BT) and/or other additional and/or alternative information that may be included within or appended to the UID.

The peripheral devices 212 of the point-of-sale system 24 may further optionally include a near-field communication interface 224, as illustrated in dashed-line configuration in FIG. 2, which may be included in embodiments in which one or more of the mobile communication devices 16₁-16_{J} also has such a near-field communication device such that customer information, e.g., customer identification information such as EMSIDs, user names, passwords, or the like, and/or customer payment information, e.g., credit/debit card information or the like, can be transferred from such one or more of the mobile communication devices 16₁-16_{J} to the point-of-sale system 24 by tapping the two near-field communication devices together or by passing the near-field communication device of a so-equipped mobile communication device 16₁-16_{J} sufficiently close to the near-field communication device 222 to effectuate such communication. Illustratively, customers may additionally transfer customer identification information to the point-of-sale system 24 via the payment interface 214, item scanner 216 or other peripheral device(s).

The point-of-sale system 24 further includes hardware infrastructure 230 which forms the structural backbone of the point-of-sale system 24. Examples of structural components that may be included in the hardware infrastructure 230 include, but should not be limited to, one or more purchased item transport units, e.g., one or more purchased item conveyance units or systems, one or more conventional purchased item bagging areas, e.g., one or more conventional item bagging carousals, one or more purchased item support units, and the like. The one or more actuators 228 may be or include any actuator that is controllable by at least one of the one or more conventional controllers 226, and which may facilitate operation and/or control of the hardware infrastructure of the point-of-sale system 24. Examples of such one or more actuators may include, but should not be limited to, one or more linear and/or rotational drive motors, one or more electronically controlled switches, and the like.

Referring now to FIG. 3A, an embodiment of one of the mobile communication devices 16 illustrated in FIG. 1 is shown, which includes components similar to the main server 12 and also to the one or more local hub servers 22₁-22_{L} and the one or more POS systems 24₁-24_{M}, 24₁-24_{N}, such as a processor 300, an I/O subsystem 302, a memory 304 including an EMS module 308, a data storage device 306, communication circuitry 312 and a number of peripheral devices 314. In some embodiments, each of the foregoing components may be identical to corresponding components of the local hub server 22₁ and/or POS system 24 described above, and a detailed explanation of such components will not be repeated here for brevity. In other embodiments, any of the one or more mobile communication devices 16₁-16_{J} may be configured differently than the local hub server 22₁ described above. It will be appreciated that the mobile communication device 16 may include other components, sub-components, and devices commonly found in a computer and/or computing device.

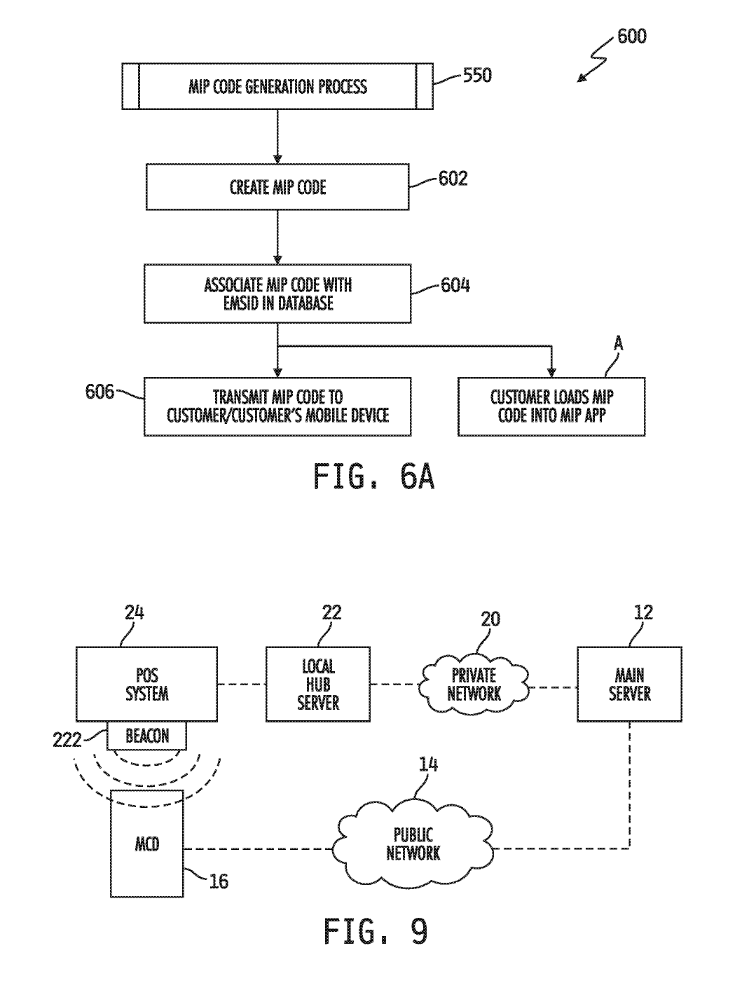

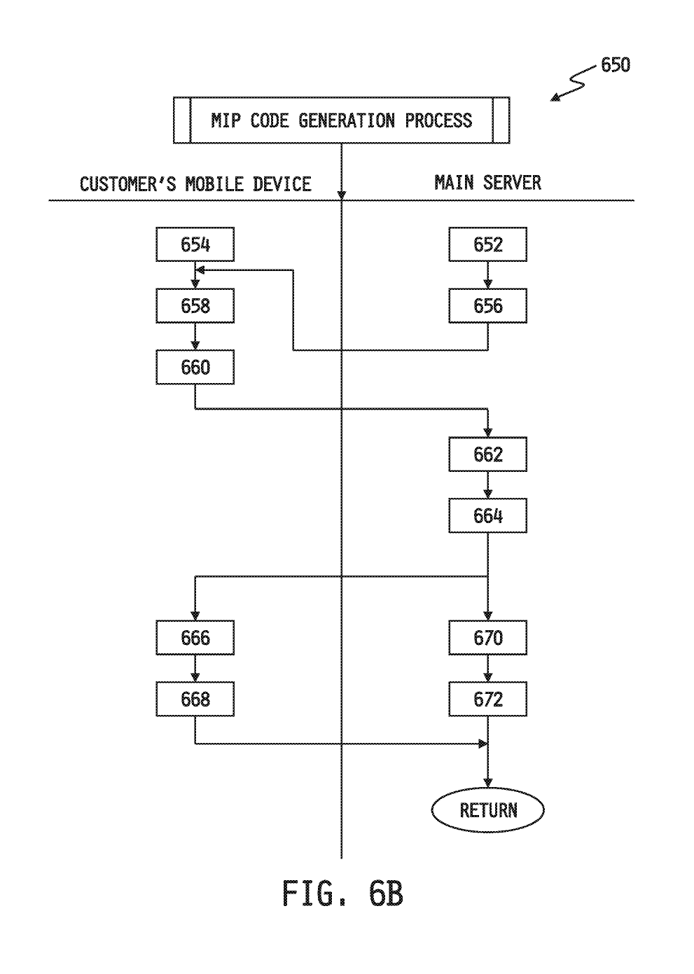

The memory 304 illustratively includes an EMS module 308 in the form of, e.g., instructions executable by the processor 300 to communicate customer-member information to and from the main server 12, and to control one or more local peripheral devices to facilitate communications between customer-members of the enterprise membership service (EMS) program and the main server 12 and to facilitate customer input of customer-identifying information, e.g., an EMS identifying number and/or code (EMSID). The memory 304 further illustratively includes a mobile identification/payment passcode or pin (MIP) application 310 in the form of, e.g., instructions executable by the processor 300 to facilitate transfer by the mobile communication device 16 of one or more unique codes to the main server 12 during a transaction for the purchase of one or more items at one of the point-of-sale systems 24₁-24_{M}, 24₁-24_{N} for one example purpose of identifying to the main server 12 a pre-selected electronic payment system to automatically process for payment of the items. Example embodiments of the MIP application 310 will be described in greater detail hereinafter with respect to FIGS. 6A and 6B.

The communication circuitry 312 illustratively includes conventional wireless communication circuitry 316 configured to facilitate communication with the main server 12 via the network 14, and the mobile communication device 16 may use any suitable communication protocol to communicate with the corresponding main server 12. The communication circuitry 312 of the mobile communication device 16 may further optionally include conventional contact-less communication circuitry 318, which may include a conventional near-field communication device 320, as illustrated by dashed-line representation in FIG. 3A. The near-field communication device 320 may be included, for example, in embodiments in which one or more of the point-of-sale systems 24₁-24_{M}, 24₁-24_{N} also has/have a near-field communication interface 222 such that customer information, e.g., customer identification information in the form of one or more identification codes (e.g., EMSID), user names, passwords, or the like, and/or customer payment information, e.g., credit/debit card information or the like, can be transferred from the mobile communication device 16 to such one or more point-of-sale systems 24₁-24_{M}, 24₁-24_{N} by tapping the two near-field communication devices together or by passing the near-field communication device 320 of the mobile communication device 16 sufficiently close to the near-field communication interface 222 to effectuate such communication. In addition to, or alternatively to, the number of peripheral devices 40 of the local hub server 22₁ described above, the number of peripheral devices 314 of the mobile communication device 16 may include any number of other or additional peripheral or interface devices. One example of such an additional peripheral device illustrated in FIG. 3A includes, but should not be limited to, a conventional visual display unit or screen 322.

Referring now to FIG. 3B, an embodiment of one of the user computing devices 18 illustrated in FIG. 1 is shown, which includes components similar to the main server 12 and also to the one or more local hub servers 22₁-22_{L} and the one or more POS systems 24₁-24_{M}, 24₁-24_{N}, such as a processor 350, an I/O subsystem 352, a memory 354 including an EMS module 358, a data storage device 356, communication circuitry 360 and a number of peripheral devices 366. In some embodiments, each of the foregoing components may be identical to corresponding components of the local hub server 22₁ and/or POS system 24 described above, and a detailed explanation of such components will not be repeated here for brevity. In other embodiments, any of the one or more user computing devices 18₁-18_{K} may be configured differently than the local hub server 22₁ described above. It will be appreciated that the user computing device 18 may include other components, sub-components, and devices commonly found in a computer and/or computing device. In any case, the communication circuitry 360 illustratively includes conventional wireless communication circuitry 364 configured to facilitate communication with the main server 12 via the network 14, and the user computing device 18 may use any suitable communication protocol to communicate with the corresponding main server 12. In addition to, or alternatively to, the number of peripheral devices 40 of the local hub server 22₁ described above, the number of peripheral devices 366 of the user computing device 18 may include any number of other or additional peripheral or interface devices. One example of such an additional peripheral device illustrated in FIG. 3B includes, but should not be limited to, a conventional visual display unit 366.

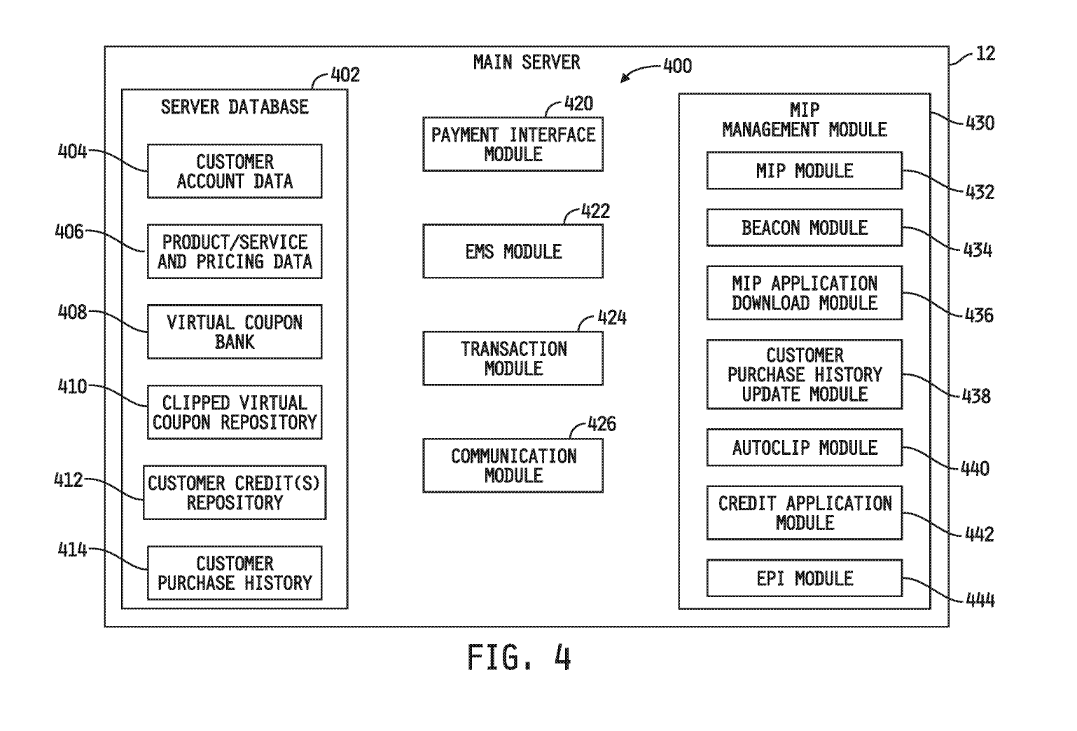

Referring now to FIG. 4, a simplified block diagram is shown of an embodiment of an environment 400 of the main server 12 illustrated in FIG. 1. In the embodiment shown in FIG. 4, the environment 400 includes a server database 402 which illustratively includes customer account data 404, product/service and pricing data 406, a virtual coupon bank 408, a clipped virtual coupon repository 410, a customer credit repository 412 and customer purchase history data 414.

Customers may elect to participate in an enterprise membership services (EMS) program offered, managed and maintained by the retail enterprise 11, by establishing a user account (which may be referred to herein as an “EMS account” or “customer account”) within the server 12, which user account may in some cases be an individual account accessible only by an individual person, e.g., an individual customer, and in other cases may be a group or “household” account accessible by each of a plurality of members of a predefined group of persons, e.g., members of a family or household, one or more employees of a business enterprise, etc. The terms “shopper,” “member,” “customer member,” “customer” and “household,” and variants thereof, are used interchangeably in the following description, and such terms should be understood to refer interchangeably to an individual customer or shopper or a predefined group of individual shoppers (referred to herein as a “household”) who shop at and purchase items from a retail enterprise, and who are members of an enterprise membership service (EMS) of the type described herein and provided and managed by the retail enterprise 11.

Illustratively, a software application program is available for download from the main server 12 via the public network 14 for shoppers electing to access the EMS program via their mobile communication device, e.g., one of the mobile communication devices 16₁-16_{J}. Once downloaded and activated, shoppers can access and manage their EMS account and program features via the software application program executed by their mobile communication device 16₁-16_{J}. Illustratively, the main server 12 additionally hosts and controls an EMS website accessible via the public network 14, and in such embodiments shoppers can access and manage their EMS accounts and program features by accessing their EMS page(s) of the EMS website hosted by the main server 12 via a computing device 18₁-18_{L} and/or via their mobile communication device 16₁-16_{J} if the latter is equipped with a web browser.

In the illustrated embodiment, the customer account data 404 of the server database 402 has stored therein information relating to user accounts and profile data for each of the members of the EMS program. As shoppers join the EMS program, the server 12 establishes an EMS account within the customer account data 404 that is unique to the customer, and assigns to the shopper, and/or the shopper selects, a unique, corresponding enterprise membership services identification code, EMSID, as briefly described hereinabove. The EMSID associated with each customer is entered into the server 12 is stored along with the customer's profile data in the customer account data 404, and can be used thereafter to access the customer's EMS account.

In some embodiments, the EMSID may be provided on or as part of one or more of a shopper's ID card, an ID associated with an RFID tag, which RFID tag may be part of the NFC communication circuitry of the mobile communication device 16₁, a shopper's incentive card, or the like. In other embodiments, the EMSID may not be provided in or as part of any tangible form, and may instead be or include one or more easily remembered sequences of numbers, letters, symbols or other characters. In any case, customer members of the EMS program described herein may scan or otherwise communicate or enter via a keypad or touchscreen their EMSID at one of the point-of-sale terminals 24₁-24_{M} (or 24₁-24_{N}), and it is through the customer's EMSID that the main server 12 makes virtual discount offers available to the customer and/or associates purchases made by the customer with the customer's purchase history to thereby monitor and track purchases made by the customer from the retail enterprise 11 during purchase transactions. MPERKS®, a virtual customer coupon collection and redemption program offered to customers by Meijer, Inc. of Grand Rapids, Mich., is an example of one such EMS program of the type described herein, although it will be appreciated that any retail enterprise membership service which offers virtual discount coupons and/or other benefits to shopper members, and/or which tracks items purchased by shopper members during item purchase transactions at point-of-sale systems or terminals may be alternatively be used.

When a member shopper manually enters the member shopper's EMSID into one of the point-of-sale system 24₁-24_{M}, 24₁-24_{N} as part of a purchase transaction (e.g., during the purchase transaction or as part of the process of commencing the purchase transaction), the processor 200 of the point-of-sale system 24₁-24_{M}, 24₁-24_{N} communicates the EMSID to the main server 12 which identifies the shopper via the EMSID and associates that shopper with the current purchase transaction being carried out at the corresponding point-of-sale system 24₁-24_{M}, 24₁-24_{N}. As will be described in greater detail below, the member shopper's EMSID may, in some embodiments, be automatically provided, via the member shopper's mobile communication device 16, to the main server 12 during a purchase transaction in a manner that is transparent to the member shopper and that does not require the member shopper to perform any manual acts other than to carry the member shopper's mobile communication device 16. In any case, all such purchase transaction data relating to items purchased by such an identified customer during a purchase transaction carried out via one of the point-of-sale system 24₁-24_{M}, 24₁-24_{N} of the retail enterprise 11 is illustratively stored in the customer purchase history database 414 where it is associated with the identified customer via the customer's EMSID. Illustratively, the purchase transaction data stored in the customer purchase history database 414 may include, but is not limited to, product/service identification information, product/service pricing, product purchase date and time, total quantity of products purchased, total quantity of identical products purchased, total transaction price, and the like.

The product/service and pricing data 406 contains information relating to the retail products and services sold by the retail enterprise 11 which the main server 12 serves. Illustratively such information may include, but is not limited to, product/service description information including product/service manufacturer, product/service family or brand, primary product type (e.g., canned tomatoes), secondary product type (e.g., canned diced tomatoes), tertiary product type (e.g., canned diced tomatoes Italian style), etc., product container size (e.g., 12 oz. can, 32 oz. can, 16 oz. package, etc.), product/service pricing information, product/service unit pricing information, current product inventory, ordered product data, product sales history, product/service location within the corresponding retail outlet, and the like. Illustratively, product/service pricing information is linked to product/service identification information via scan codes, e.g., scannable bar codes such as Universal Product Codes (UPC) or the like, such that when items are scanned for purchase, the scan code of each item will identify a particular item at a particular price in the product/service and pricing database 406.

In some embodiments, the main server 12 illustratively provides, as part of the EMS program described herein, discount offers to member shoppers for one or more items purchasable from the business enterprise, e.g., in the form of one or more corresponding virtual discount coupons. In this regard, each member shopper is provided by the main server 12 with access to dedicated portion of a customer virtual coupon repository database in which virtual discount coupons specific to the member shopper or customer are stored and via which the member shopper may access and redeem one or more virtual discount coupons. In one embodiment, the server database 402 includes a plurality of customer virtual coupon repositories; one for each of the plurality of member shoppers. Alternatively, the server database 402 may include a single repository, and each member shopper of the EMS program is provided with access to a dedicated portion of the repository; i.e., which can be accessed by one shopper to the exclusion of all other shopper members. The server database 402 further illustratively includes a clipped virtual coupon repository 410 in which virtual discount coupons “clipped” by shopper members, i.e., selected for redemption, are stored. The server database 402 may include a single such repository 410, and each member shopper of the EMS program may be provided with access to a dedicated portion of the repository 410; i.e., which can be accessed by one shopper to the exclusion of all other shopper members, or a separate repository 410 for each member shopper. The virtual coupon bank 408 illustratively has stored therein virtual discount coupons that are received from an external source and from which the customer virtual coupon repositories may be populated, e.g., periodically, aperiodically and/or on an ad hoc basis.

In some embodiments, the main server 12 illustratively provides, as part of the EMS program described herein, credit repositories in which to store one or more retail enterprise credits, e.g., in the form of digital currency. In this regard, each member shopper is provided by the main server 12 with access to dedicated portion of a customer credit repository database 412 in which one or more credit amounts specific to the member shopper or customer are stored and via which the member shopper may access and redeem one or more credit amounts for purchases made at the retail enterprise 11. In one embodiment, the server database 402 includes a plurality of customer credit repositories 412; one for each of the plurality of member shoppers. Alternatively, the server database 402 may include a single credit repository 412, and each member shopper of the EMS program is provided with access to a dedicated portion of the repository 412; i.e., which can be accessed by one shopper to the exclusion of all other shopper members.

The environment 400 of the main server 12 further includes a payment interface module 420, an EMS module 422, a transaction module 424 and a communication module 426. In one embodiment, the payment interface module 420 is configured, in a conventional manner, to process tangible forms of electronic payment systems (EPS), e.g., tangible electronic funds transfer instruments such as credit cards, debit cards, etc., used at the point-of-sale systems 24₁-24_{M}, 24₁-24_{N}. In an example of such embodiments, the payment interface module 420 illustratively is or includes a conventional magnetic strip reading device configured to read payment information stored in magnetic form on a strip affixed to a conventional credit or debit card. Alternatively or additionally, the payment interface module 420 may be or include the NFC interface 224, and in such embodiments the NFC interface 224 is configured to access, via contact or near-contact with a portable electronic device having a like-configured NFC device 320, electronically readable customer payment system (EPS) information stored on or accessible by the portable electronic device.

The EMS module 422 is configured to control and manage EMS-related activity of shopper members of the EMS program. The communication module 426 is configured, in a conventional manner, to control and manage all communications between the main server 12 and the local hub servers 22₁-22_{L} in embodiments that include the local hub servers 22₁-22_{L}, and to control and manage all communications between the main server 12 and all point-of-sale systems 24₁-24_{M}, 24₁-24_{N} in embodiments that do not include a local hub server 22₁-22_{L}.

The customer payment interface 214 and item scanner 216 of the point-of-sale systems 24₁-24_{M}, 24₁-24_{N}, together with the payment interface module 420 of the main server 12, make up a product purchase interface a customer-accessible portion of which is provided in the form of the point-of-sale terminals or systems 24₁-24_{M}, 24₁-24_{N} physically located at a brick-and-mortar location of the business enterprise. In some embodiments, the payment interface module 420 and the transaction module 424 of the main server 12 are operable to control all purchase transactions made at any of the point-of-sale systems 24₁-24_{M}, 24₁-24_{N}, and in such embodiments the processors 200 of the point-of-sale systems 24₁-24_{M}, 24₁-24_{N} are operable to control the various peripheral devices 212 based on instructions from the processor 50 of the main server and to provide information relating to purchase transactions taking place at the point-of-sale systems 24₁-24_{M}, 24₁-24_{N} back to the processor 50. In other embodiments, the processors 200 of the point-of-sale systems 24₁-24_{M}, 24₁-24_{N} may control some or all aspects of the purchase transactions made thereat. In any case, the communication module 426 is configured, in a conventional manner, to control and manage all communications between the main server 12 and the local hub servers 22₁-22_{L} via the network 20 (an to thereby control and manage all communications between the main server 12 and the point-of-sale systems 24₁-24_{M}, 24₁-24_{N}), to control and manage all communications between the main server 12 and the mobile communication devices 16₁-16_{J} via the network 14 and to also control and manage all communications between the main server 12 and the user computing devices 18₁-18_{K} via the network 14.

The transaction module 424 is configured to monitor purchases of products and services made by shopper members of the EMS program using any of the point-of-sale systems 24₁-24_{M}, 24₁-24_{N}, and to store purchase transaction data associated with such purchases in the customer purchase history database 408. Illustratively, the customer purchase history database 414 is partitioned or otherwise configured to store such purchase transaction data in a manner that provides for the separate tracking and identification of some or all of the shopper purchase history of each shopper (or household) member.

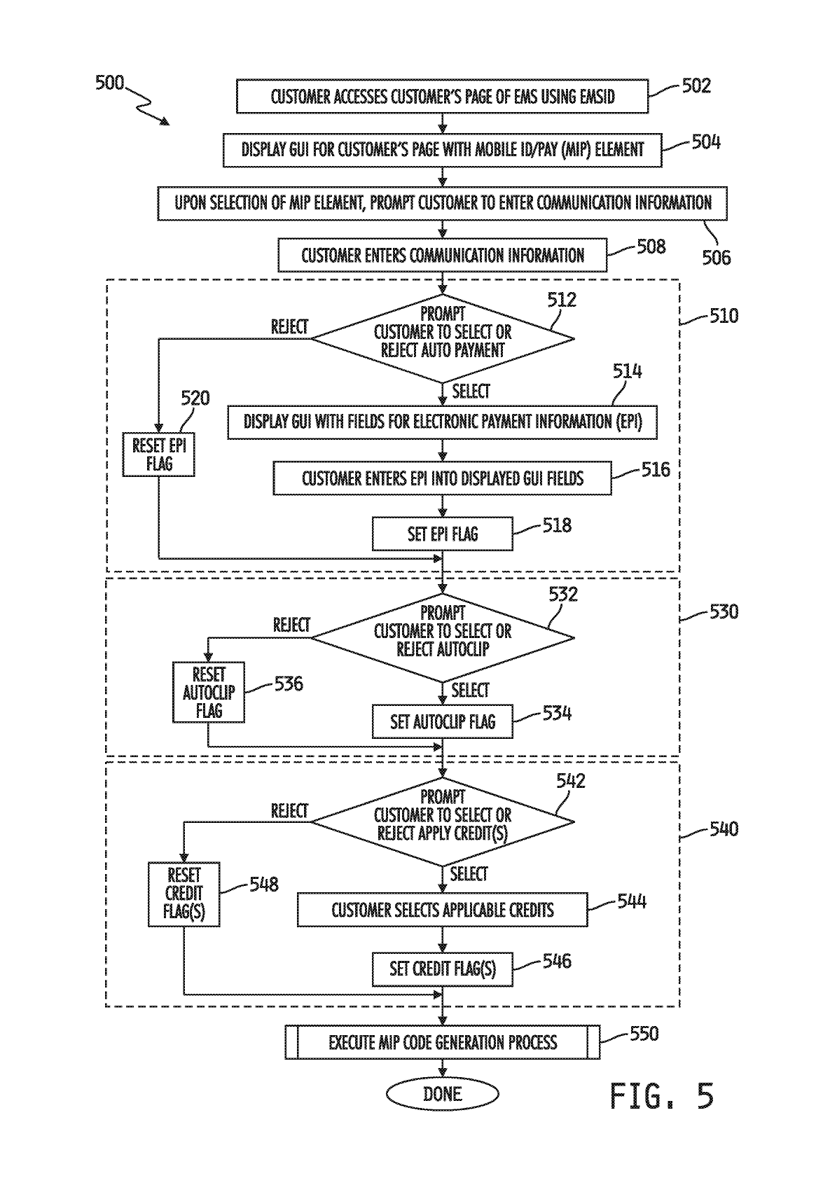

The environment 400 of the main server 12 further illustratively includes an MIP management module 430 which illustratively includes an MIP module 432, a wireless signal broadcasting device module 434, an MIP application download module 436, a customer purchase history update module 438, an auto-clip module 440, a credit application module 442 and an EPI module 444. The MIP module 432 is illustratively operable to provide, control and manage a customer interface to the EMS program, e.g., a web-based EMS interface or EMS website to provide for customer entry of automatic purchase payment preferences and to control and implement such preferences during subsequent purchase transactions made by customer members of the EMP program at any of the point-of-sale interfaces 24₁-24_{M}, 24₁-24_{N}. Example embodiments of processes executed by the MIP module 432 are illustrated in FIGS. 5, 6A, 6B, 7 and 8, and such processes will be described in detail hereinafter.

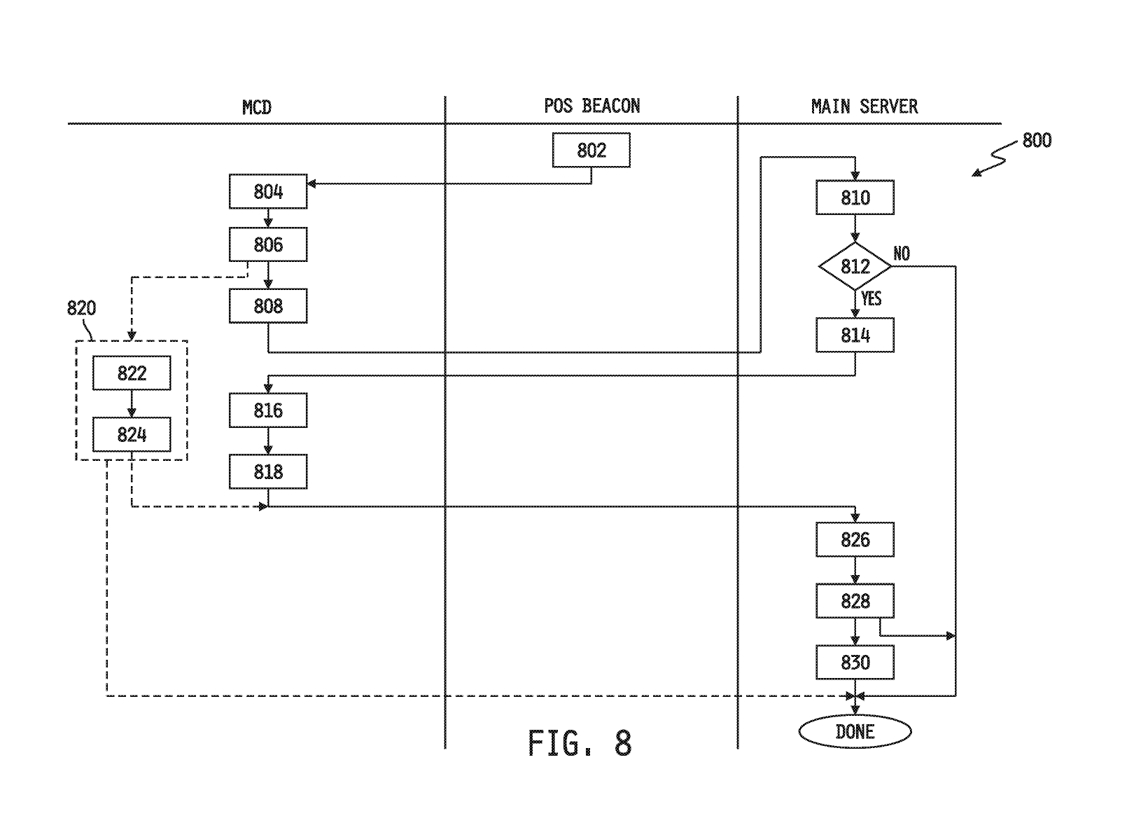

The wireless signal broadcasting device module 434 illustratively contains information about each wireless signal broadcasting device 222 in the retail enterprise. In some embodiments, such wireless signal broadcasting device information includes unique identification codes (UID) of each wireless signal broadcasting device 222. In other embodiments, the wireless signal broadcasting device information may additionally include wireless signal broadcasting device type information identifying or associating a wireless signal broadcasting device type, BT, with each wireless signal broadcasting device 222. In some such embodiments, the wireless signal broadcasting device information may be stored, e.g., separately, in the module 434 according to wireless signal broadcasting device type. In some embodiments, the wireless signal broadcasting device module 434 may include additional information including, for example, but not limited to, positional information corresponding to the coordinates of some or all of the wireless signal broadcasting devices 222 of the retail enterprise 11 and/or of one or more brick-and-mortar outlets thereof, relative to one or more sets of base coordinates, positional information corresponding to the coordinates of some or all of the point-of-sale systems 24₁-24_{M}, 24₁-24_{N} of the retail enterprise 1 and/or of one or more brick-and-mortar outlets thereof, relative to one or more sets of base coordinates. The wireless signal broadcasting device module 434 is further illustratively operable to process wireless signal broadcasting device-related information transmitted to the main server 12 by customers' mobile communication devices 16₁-16_{J}, and to control transmission of corresponding and related information back to the customers' mobile communication devices 16₁-16_{J}. Example embodiments of processes executed by the wireless signal broadcasting device module 434 are illustrated in FIG. 8, and such processes will be described in detail hereinafter.

The MIP application download module 436 illustratively contains the MIP application 310 illustrated and described with respect to FIG. 3A. Example embodiments of processes executed by the processor 300 of the customer mobile communication devices 16₁-16_{J} according to the MIP application are illustrated in FIGS. 6A, 6B, 7 and 8, and such processes will be described in detail hereinafter.

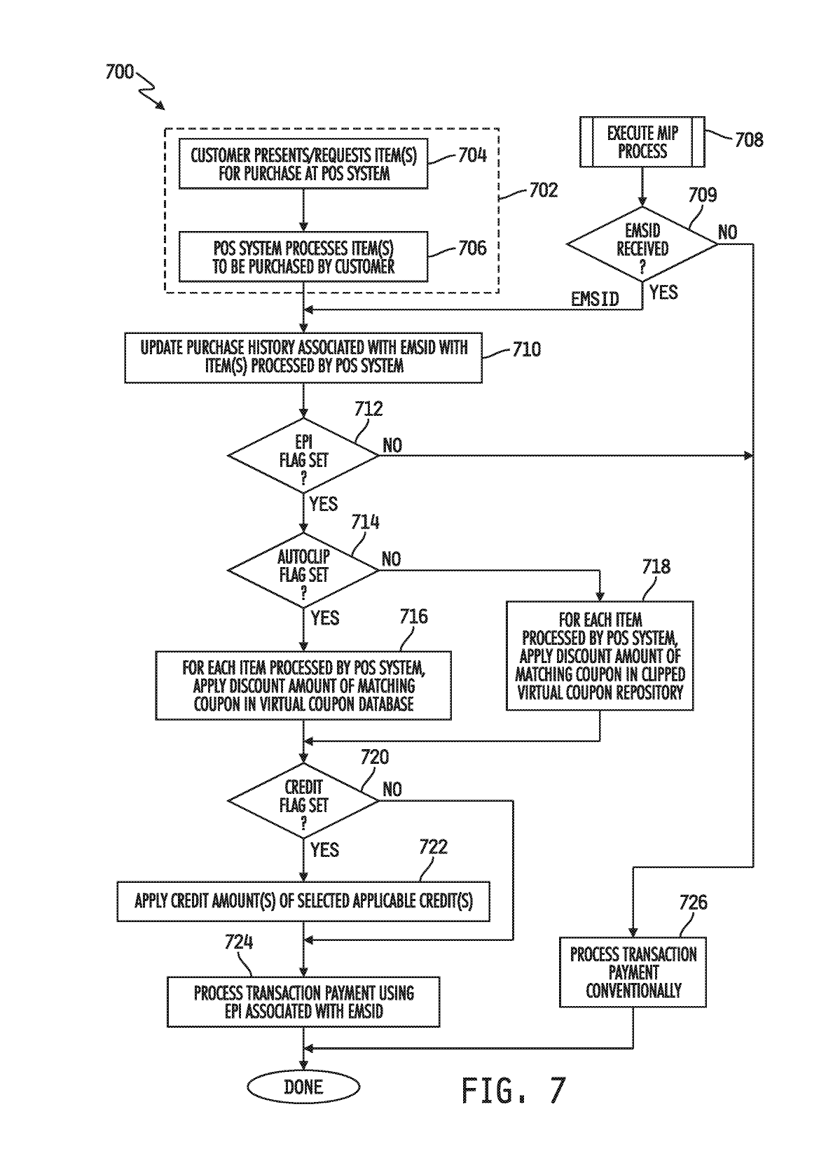

The customer purchase history update module 438 is illustratively operable to automatically update customer purchase histories within the customer purchase history data 414 of the database 402. An example embodiment of a process executed by the customer purchase history update module 438 is illustrated in FIG. 7, and such a process will be described in detail hereinafter.

The auto-clip module 440 is illustratively operable to automatically apply discount amounts of virtual discount coupons in the virtual coupon bank to applicable items purchased by customers. Example embodiments of processes executed by the auto-clip module 440 are illustrated in FIGS. 5 and 7, and such processes will be described in detail hereinafter.

The credit application module 442 is illustratively operable to automatically apply credit amounts pre-authorized by customers to total purchase amounts, and/or to the purchase amounts of one or more specified items and/or item categories, in purchase transactions made by customers at the retail enterprise 11. Example embodiments of processes executed by the credit application module 442 are illustrated in FIGS. 5 and 7, and such processes will be described in detail hereinafter.

The EPI module 444 is illustratively operable to automatically process an electronic payment system, EPS, pre-designated by customers for purchase transactions made by customers at the retail enterprise 11. Example embodiments of processes executed by the EPI module 444 are illustrated in FIGS. 5 and 7, and such processes will be described in detail hereinafter.

Referring now to FIG. 5, a simplified flow diagram is shown depicting an embodiment of a process 500 for facilitating entry by a customer into the customer's EMS account, e.g., within the customer account data 404 of the database 402, electronic payment information (EPI) for an electronic payment system (EPS) that the customer authorizes, e.g., by entry of the EPI for the specified EPS into the customer's EMS account, the main server 12 to automatically process in future transactions as payment for the purchase via one of the point-of-sale systems 24₁-24_{M}, 24₁-24_{N} of one or more items from the retail enterprise 11. Such a process may be referred to herein as an “auto-payment feature.” The process 500 further illustratively includes a process for creating or generating a mobile identification passcode or pin (MIP code) to associate with the authorized EPS for the purpose of identifying and authorizing access by the main server 12 to the authorized EPS in any such future purchase transaction in which the authorized EPS is automatically processed by the main server 12. Example embodiments of the MIP generation process are illustrated in FIGS. 6A and 6B, and each will be described in detail hereinafter. The process 500 may optionally further include a process for allowing customers to authorize automatic clipping and redemption of any virtual discount coupon contained in the virtual coupon bank 408 that matches any item included in any such future purchase transaction in which the authorized EPS is automatically processed by the main server 12. Such a process may be referred to herein as an “auto-clipping feature.” The process 500 may still further optionally include a process for allowing customers to authorize automatic deduction of any specified credit amount existing in the customer's credit repository 412 from a total amount due, and/or from the purchase amount(s) of one or more specified items and/or item categories, in any such future purchase transaction in which the authorized EPS is automatically processed by the main server 12. Such a process may be referred to herein as an “auto-credit feature.”

In one embodiment, the process 500 is stored in the memory 54 (and/or data storage 56) of the main server 12 in the form of instructions executable by the processor 50 of the main server 12, and the process steps of the process 500 will be described below for purposes of this disclosure as being executed by the processor 50 of the main server 12. It will be understood, however, that in some alternate embodiments, the process 500 may be alternatively stored, in whole or in part, in the memory 34 (and/or data storage 36) of the one or more of the local servers 22₁-22_{L} in the form of instructions executable, in whole or in part, by the processor 30 of one or more of the local servers 22₁-22_{L}, and in other embodiments the process 500 may be stored, in whole or in part, in the memory 202 (and/or data storage 206) of the one or more of the POS systems 24₁-24_{M}, 24₁-24_{N} in the form of instructions executable, in whole or in part, by the processor 200 of one or more of the one or more of the POS systems 24₁-24_{M}, 24₁-24_{N}, and in still other embodiments which include one or more enterprise servers 26 as illustrated in FIG. 1, the process 500 may be stored, in whole or in part, in a memory of the enterprise server(s) 26 in the form of instructions executable, in whole or in part, by a processor of the enterprise server(s) 26. In any such embodiments, the process 500 may be executed in whole or in part by one or more processors within any one or a combination of the main server 12, any of the one or more local servers 22₁-22_{L}, any of the one or more of the POS systems 24₁-24_{M}, 24₁-24_{N} and the enterprise server(s) 26, wherein information may be shared between the such systems via wired and/or wireless connection.

The process 500 operates separately with respect to each enterprise membership service account number, i.e., each EMSID. In this regard, the process 500 begins at step 502 where the processor 50 is operable to determine that a customer has accessed that customer's page of the EMS interface, e.g., an access page of one or more dedicated and private pages of the EMS website hosted by the main server 12 and associated or assigned to the customer, using the customer's EMSID. Access by the customer of the customer's page of the EMS interface may be accomplished, for example, using a mobile communication device 16 or a user computing device 18. In any case, upon detection of such access by the customer of the customer's page of the EMS interface, the process 500 advances to step 504 where the processor 50 is operable to generate and include for display on the accessed customer's page of the EMS interface a graphic user interface (GUI) which includes a mobile identification/payment passcode or pin (MIP) element. Upon selection by the customer of the MIP element, the processor 50 is operable at step 506 to generate for display on the accessed customer's page of the EMS interface a prompt for the customer to enter communication information, and thereafter at step 508 the customer enters into the EMS interface the communication information requested by the processor 50. Illustratively, the communication information requested by the processor 50 and entered into the EMS interface is or includes one or more communication code(s), e.g., in the form of one or more sequences of numbers, letters of any alphabet, punctuation symbols and/or other symbols, that identifies a mobile communication device 16 that will be used by the customer to communicate with the main server during purchase transactions in which the authorized EPS will be automatically processed by the main server 12. In one embodiment, the communication may be or include the telephone number of the identified mobile communication device 16. In other embodiments, the communication information may be or include, in place of or in addition to the telephone number of the identified mobile communication device 16, one or more other unique mobile communication device identification codes that identify the specified mobile communication device 16 for purposes of wireless communication therewith. In embodiments in which the customer's EMS account already includes or has access to the communication code of the customer's mobile communication device, steps 506 and 508 may be omitted or modified to require the customer to acknowledge and authorize use thereof by the processor 50, for generation of an MIP code, and/or modified to allow the customer to authorize use by the processor 50, for generation of an MIP code, of a communication code other than that identified in the customer's EMS account. In any case, following execution of step 508, the communication information obtained to which the processor 50 has access identifies a communication code for a mobile communication device 16, e.g., telephone number, address or other code via which wireless communications with the mobile communication device 16 can be conducted, with which the processor 50 is authorized to communicate during future purchase transactions in which the authorized EPS is to be automatically processed by the main server 12.

The process 500 advances from step 508 to step 510 which includes a process by which the customer specifies and authorizes an EPS that will be automatically processed in future purchase transactions by the processor 50 of the main server 12 as payment for the purchase of one or more items via one of the point-of-sale systems 24₁-24_{M}, 24₁-24_{N} from the retail enterprise 11. An example embodiment of a process by which the processor 50 of the main server 12 automatically processes such an authorized EPS as payment for the purchase of one or more items via one of the point-of-sale systems 24₁-24_{M}, 24₁-24_{N} from the retail enterprise 11 is illustrated in FIG. 7 and will be described in detail hereinafter.

The process illustrated in step 510 illustratively includes step 512 where the processor 50 is operable to generate for display on the accessed customer's page of the EMS interface a prompt for the customer to select or reject the auto-payment feature. By selecting the auto-payment option, the customer authorizes the main server 12 to automatically process an EPS that the customer will subsequently identify as payment for the purchase of one or more items via one of the point-of-sale systems 24₁-24_{M}, 24₁-24_{N} from the retail enterprise 11. In such cases, the process illustrated in step 510 advances from step 512 to step 514 where the processor 50 is operable to generate and include for display on the accessed customer's page of the EMS interface, or as a new page for display on the accessed customer's page of the EMS interface, an EPS graphic user interface (EPS GUI) with a plurality of fields in which the user can enter electronic payment information (EPI) associated with an EPS selected by the customer. Thereafter at step 516, the customer enters the EPI of a selected EPS into the plurality of EPS GUI fields, and the processor 50 sets an EPI flag. If, at step 512 the customer instead rejects the auto-payment option, the main server 12 will not automatically process an EPS as payment for the purchase of one or more items via one of the point-of-sale systems 24₁-24_{M}, 24₁-24_{N} from the retail enterprise 11, and the process 500 advances to step 520 where the processor 50 resets the EPI flag. In some embodiments, the status of the EPI flag may be used by the processor 50 during subsequent transactions by the customer for the purchase of one or more items via one of the point-of-sale systems 24₁-24_{M}, 24₁-24_{N} from the retail enterprise 11 to determine whether or not to process an authorized EPS for auto-payment. Those skilled in the art will recognize that use of such a flag represents only one technique for making such a determination, and that other conventional software techniques may alternatively or additionally be used to make such a determination. In any case, the process 500 advances from the completion of either of the steps 518 and 520 to a next step in the process 500 as will be described below.

As used herein, the term “electronic payment system” or “EPS” refers generally to any instrument of electronic funds transfer that is identifiable by an account number, card number, access number, code or other identification and that may be used by a customer and accepted by the retail enterprise 11 in the course of a purchase transaction to satisfy payment for items purchased by the customer from the retail enterprise 11 via a one of the point-of-sale systems 24₁-24_{M}, 24₁-24_{N}. Examples of such instruments of electronic funds transfer include, but are not limited to, credit cards, debit cards, pre-paid credit cards, on-line money transfer accounts, wire transfer accounts, electronic or digital money certificates and/or accounts, ecommerce payment systems, and the like.

As used herein, the term “electronic payment information” or “EPI” refers generally to information uniquely associated with an EPS that identifies the EPS for purposes of transferring funds from the EPS to the retail enterprise 11. In some embodiments, the EPI may be or include an account or identification number or code that specifically identifies the EPS, e.g., a credit card number. In other embodiments, the EPI may include one or more numbers or codes, e.g., a security code, in addition to the identification number or code. Any such “code” referred to in herein will be understood to be a unique combination, at least for purposes of identifying an EPS account, of one or more numerical digits, one or more letters of an alphabet in any language, one or more punctuation symbols and/or one or more symbols other than punctuation symbols.

In still other embodiments, the EPI may include information alternatively to, or in addition to, an account or identification number/code (and, in some embodiments, further alternatively to or in addition to a security number/code), examples of which may include the name of the person to whom the EPS is issued, birthdate of the person to whom the EPS is issued, part or all of the address of the person to whom the EPS is issued, part or all of the billing address of the payer or other funding source of the EPS, contact information, such as one or more telephone or mobile phone numbers, one or more email addresses, etc. of the person to whom the EPS is issued and/or of the payer or other funding source of the EPS, identity of and/or other information about the EPS issuer, the EPS payment processing organization, e.g., Visa®, MasterCard®, etc., or the like. It will be understood that “EPI,” as used herein, may be or include one or any combination of any of the foregoing numbers, codes and/or information, and that information about the EPS, in addition to EPI, may be required by the process 500 to be entered by the customer into the EPS GUI displayed at step 514. As one specific example, the EPI in one embodiment may be defined completely by a combination of an account or identification number and security code of the EPS, although the process 500 may additionally require some or all of the information just described to be entered into the displayed EPS GUI in order to completely satisfy step 516, i.e., in order for the process 500 to advance from step 516 to step 518.

In one embodiment, the EPI is stored by the processor 50 in the customer account data 404 of the database 402. In alternate embodiments, the EPI may be stored, in whole or in part, elsewhere in one or more other databases or memory units within or outside of the system 10.

The process 500 may optionally include a step 530 to which the process 500 illustratively advances from step 510. Step 530, in embodiments of the process 500 that include step 530, illustratively includes an embodiment of the auto-clipping feature in which customers may selectively authorize automatic clipping and redemption of any virtual discount coupon contained in the virtual coupon bank 408 that matches any item included in any such future purchase transaction in which the authorized EPS is automatically processed by the main server 12. In the illustrated embodiment, such a process includes step 532 in which the processor 50 is operable to generate for display on the accessed customer's page of the EMS interface a prompt for the customer to select or reject the auto-clipping feature. By selecting the auto-clipping feature, the customer authorizes the main server 12 to clip and redeem any virtual discount coupon contained in the virtual coupon bank 408 that matches an item included in a future purchase transaction in which an authorized EPS is automatically processed by the main server 12 for payment of items to be purchased. In such cases, the process illustrated in step 530 advances from step 532 to step 534 where the processor 50 is operable to set an autoclip flag. If, at step 532 the customer instead rejects the auto-clipping feature, the main server 12 will not automatically clip and redeem any virtual discount coupon contained in the virtual coupon bank 408 that matches an item included in a future purchase transaction in which an authorized EPS is automatically processed by the main server 12 for payment of items to be purchased, and the process 500 advances from step 532 to step 536 where the processor 50 resets the autoclip flag. In some embodiments, the status of the autoclip flag may be used by the processor 50 during subsequent transactions by the customer for the purchase of one or more items via one of the point-of-sale systems 24₁-24_{M}, 24₁-24_{N} from the retail enterprise 11 to determine whether or not to carry out the auto-clipping feature. Those skilled in the art will recognize that use of such a flag represents only one technique for making such a determination, and that other conventional software techniques may alternatively or additionally be used to make such a determination. In any case, the process 500 advances from the completion of either of the steps 534 and 536 to a next step in the process 500 as will be described below.

The process 500 may optionally include a step 540 to which the process 500 illustratively advances from step 530, in some embodiments that include step 530, or from step 510 whether or not the process 500 includes step 530. Step 540, in embodiments of the process 500 that include step 540, illustratively includes an embodiment of the auto-credit feature in which customers may selectively authorize automatic deduction of any specified credit amount existing in the customer's credit repository 412 from a total amount due and/or from the purchase amount(s) of one or more specified items and/or item categories, in any future purchase transaction in which an authorized EPS is automatically processed by the main server 12. In the illustrated embodiment, such a process includes step 542 in which the processor 50 is operable to generate for display on the accessed customer's page of the EMS interface a prompt for the customer to select or reject the auto-credit feature. By selecting the auto-credit feature, the customer authorizes the main server 12 to automatically deduct all or a specified amount of credit existing in the customer's credit repository 412 from a total amount due in a purchase transaction in which the authorized EPS is automatically processed by the main server 12. In such cases, the process illustrated in step 540 advances from step 542 to step 544 where the customer selects an applicable credit amount to be deducted from the customer's credit repository in each subsequent purchase transaction in which the authorized EPS is automatically processed by the main server 12. Illustratively, step 544 may be configured such that the customer may select any desired credit amount in any form, examples of which include, but are not limited to, one or a combination of a fixed dollar and/or cent amount, an incremental dollar and/or cent amount depending upon a total amount due, a percentage of a total credit balance in the customer's credit repository 412, an incremental percentage of a total credit balance depending upon a total amount due, the total amount due, the total credit balance if less than the total amount due, and the like. In some embodiments, step 544 may alternatively or additionally be configured such that the customer may specify one or more specific items and/or item categories to which one or more specified credit amount(s) is/are to be applied, i.e., by deducting the specified credit amount(s) from the prices of one or more such items and/or specified categories of items included in a future purchase transaction. Examples of item categories that the customer may specify include, but are not limited to, product category, e.g., food, beverage, clothing, etc., product sub-category, e.g., dairy, meat, product, etc., item brands, e.g., Coke® products, etc., or the like. In some embodiments, specified items and/or item categories may further include exempted items and/or item categories, i.e., those items and/or item categories that credit amounts should not be applied to, e.g., restricted age products such as those containing tobacco or consumable alcohol, etc. Those skilled in the art will recognize other example items and/or item categories that may be included in step 544 in such embodiments, and it will be understood that any such other items and/or item categories are contemplated by this disclosure.

Following step 544, the processor 50 is operable at step 546 to set a credit flag. If, at step 542 the customer instead rejects the auto-credit feature, the main server 12 will not automatically deduct all or a specified amount of credit existing in the customer's credit repository 412 from a total amount due in a purchase transaction in which the authorized EPS is automatically processed by the main server 12, and the process 500 advances from step 542 to step 548 where the processor 50 resets the credit flag. In some embodiments, the status of the credit flag may be used by the processor 50 during subsequent transactions by the customer for the purchase of one or more items via one of the point-of-sale systems 24₁-24_{M}, 24₁-24_{N} from the retail enterprise 11 to determine whether or not to carry out the auto-credit feature. Those skilled in the art will recognize that use of such a flag represents only one technique for making such a determination, and that other conventional software techniques may alternatively or additionally be used to make such a determination. In any case, the process 500 advances from the completion of either of the steps 546 and 548 to a next step in the process 500 as will be described below.

The process 500 further includes a step 550 to which the process 500 illustratively advances from step 540, in some embodiments that include step 540, or from step 508, step 510 or step 530 whether or not the process 500 includes step 540. At step 550 the processor 50 is operable to execute an MIP code generation process in which the processor 50 generates an MIP code, i.e., a mobile identification passcode or pin (MIP), which will be used to by the processor 50 to identify an EPS authorized by the customer for processing of payment for the purchase of items at future purchase transactions conducted via one of the point-of-sale systems 24₁-24_{M}, 24₁-24_{N}. A number of different embodiments of the MIP code generation process executed at step 550 are illustrated by example in FIGS. 6A and 6B and will be described in detail hereinafter.

Referring now to FIG. 6A, a simplified flow diagrams is shown of an embodiment of a process 600 for executing the MIP code (mobile identification passcode or pin) generation process identified at step 550 of the process 500 illustrated in FIG. 5. In the embodiment illustrated in FIG. 6A, the MIP code is illustratively generated in a form that will be stored in, or accessed by, a mobile communication device 16 carried by the customer, which will then be automatically transferred from the mobile communication device 16 to the main server 12 during transactions for the purchase of one or more items from the retail enterprise 11 via one of the point-of-sale systems 24₁-24_{M}, 24₁-24_{N} in which an authorized EPS is to be automatically processed by the main server 12.

In one embodiment, the process 600 is stored in the memory 54 (and/or data storage 56) of the main server 12 in the form of instructions executable by the processor 50 of the main server 12, and the process steps of the process 600 will be described below for purposes of this disclosure as being executed by the processor 50 of the main server 12. It will be understood, however, that in some alternate embodiments, the process 600 may be alternatively stored, in whole or in part, in the memory 34 (and/or data storage 36) of the one or more of the local servers 22₁-22_{L} in the form of instructions executable, in whole or in part, by the processor 30 of one or more of the local servers 22₁-22_{L}, and in other embodiments the process 600 may be stored, in whole or in part, in the memory 202 (and/or data storage 206) of the one or more of the POS systems 24₁-24_{M}, 24₁-24_{N} in the form of instructions executable, in whole or in part, by the processor 200 of one or more of the one or more of the POS systems 24₁-24_{M}, 24₁-24_{N}, and in still other embodiments which include one or more enterprise servers 26 as illustrated in FIG. 1, the process 600 may be stored, in whole or in part, in a memory of the enterprise server(s) 26 in the form of instructions executable, in whole or in part, by a processor of the enterprise server(s) 26. In any such embodiments, the process 600 may be executed in whole or in part by one or more processors within any one or a combination of the main server 12, any of the one or more local servers 22₁-22_{L}, any of the one or more of the POS systems 24₁-24_{M}, 24₁-24_{N} and the enterprise server(s) 26, wherein information may be shared between the such systems via wired and/or wireless connection.

The embodiment illustrated in FIG. 6A illustratively requires the mobile communication device 16 to include the MIP application 310 described hereinabove with respect to FIG. 3A. In the embodiment illustrated in FIG. 6A, the MIP application 310 is or includes a conventional software application which, when executed by the processor 300 of the mobile communication device 16, causes the processor 300 to load the generated MIP code from a memory location within or outside of the customer's mobile communication device 16 into the MIP application 310.

In the embodiment illustrated in FIG. 6A, the MIP code generation process 600 begins at step 602 where the processor 50 is operable to create the MIP code. Illustratively, the MIP code is created by the processor 50 in the form of a passcode, pin, token or other code as one or more unique sequences of bits. In one embodiment, the one or more unique sequences may be defined by or include one or more digits, one or more letters of any alphabet, one or more punctuation symbols or one or more other symbols, and may be assembled in the form of one or more appended or integrated sequences of bits or in the form of one or more separate sequences of bits. In other embodiments, some or all of any such one or more sequences of bits may be or include one or more sequences of bits that do/does not define any digit, letter, punctuation symbol or other symbol. In some embodiments, the MIP code may be generated by the processor 50 randomly or pseudo-randomly. In other embodiments, the MIP code may be generated by the processor 50 as a function of one or more variables generally. In some such embodiments, the MIP code may be generated by the processor 50 as as a function of information relating to the customer, to the customer's EMS account, to the customer's mobile communication device 16, or as any combination thereof. Examples of information relating to the customer include, but are not limited to, customer's name, customer's address, customer's email address, or the like, examples of information relating to the customer's EMS account include, but are not limited to, the customer's EMSID, one or more portions of the EPI defined by or relating to the authorized EPS (i.e., an EPS authorized according to a process such as that illustrated at step 510 of FIG. 5), one or more portions of EPI relating to one or more additional EPSs identified within the customer's EMS account, or the like, and examples of information relating to the customer's mobile communication device 16 include, but are not limited to, any portion of the communication information provided at step 508 of the process 500 illustrated in FIG. 5 or the like.

In some embodiments the MIP may be generated solely by the processor 50. In other embodiments, customer may specify, e.g., via a suitable GUI, some or all of the MIP code. In some such embodiments in which the customer enters some of all of the MIP code, the customer-entered MIP code may act as an initial access code which the processor 50 is operable to process using any conventional processing technique to produce a second MIP code which then replaces, is integrated with or is appended to the customer-entered MIP code. Those skilled in the art will recognize other techniques for generating an MIP code that may or may not be a function of one or more variables, and it will be understood that any such alternate techniques are contemplated by this disclosure.

Following step 602, the process 600 advances to step 604 where the processor 50 is operable to associate the generated MIP code with the customer's EMSID, i.e., the EMSID entered by the customer to access the process 500. In some embodiments, the processor 50 is alternatively or additionally operable at step 604 to associate the generated MIP code with the EPI of the authorized EPS, i.e., the EPI entered by the customer at step 516 of the process 500. In one embodiment, the processor 50 is operable to execute step 604 by storing the MIP code in a database and then linking the stored MIP code to stored values of EMSID and/or EPI using one or more conventional data association techniques. Illustratively, the generated MIP code may be stored by the processor 50, in whole or in part, in the customer account data 404 of the database 402, or elsewhere in one or more other databases or memory units within or outside of the system 10. In such embodiments, the processor 50 is illustratively operable to link the stored MIP code to stored values of EMSID and/or EPI using one or more conventional linking or pointing mechanisms, examples of which include, but are not limited to, a table, a chart, a linked list or other pointer, or the like. In embodiments in which the MIP code includes the customer's EMSID, the processor 50 is illustratively operable at step 604 to associate the MIP code only with the stored value of EPI.

Following step 604, the process 600 advances to step 606 where the processor 50 is operable to transmit the generated MIP code to the customer, e.g., via email, or to the customer's mobile device 16, e.g., via a short message service (sms) or other wireless communication technique or protocol. Alternatively, the processor 50 may make the MIP code available to the customer via the customer's EMS account. In any case, outside of the process 600 controlled by the processor 50, the customer loads the MIP code into the MIP application 310 on the customer's mobile communication device 16, or into the customer's mobile communication device 16 for subsequent transfer to the MIP application 310, as illustrated in FIG. 6A by the process step A. In one embodiment, the MIP application 310 includes conventional software which guides the customer in transferring the MIP code from the customer's email or sms into the MIP application 310, and in other embodiments the MIP application 310 includes conventional software that automatically transfers the MIP code to the customer's mobile communication device 16 from the customer's EMS account or other location. Following completion of step 606, the process 600 returns to the process 500 illustrated in FIG. 5.

Referring now to FIG. 6B, a simplified flow diagram is shown of another embodiment of a process 650 for executing the MIP code (mobile identification passcode or pin) generation process identified at step 550 of the process 500 illustrated in FIG. 5. Illustratively, the process 650 may be used in addition to or in place of the MIP code generation process 600 illustrated in FIG. 6A. In the embodiment illustrated in FIG. 6B, the MIP code generation process 650 is an interactive process that takes place between the processor 50 of the server 12 and the processor 300 of a customer's mobile communication device 16, and which is therefore executed, in-part, by the processor 50 and, in-part, by the processor 300. In this regard, the process 650 is illustratively one that is stored, in one embodiment, in-part in the memory 54 (and/or data storage 56) of the main server 12 in the form of instructions executable by the processor 50 of the main server 12 and in-part in the memory 304 or data storage 306 of the mobile communication device(s) in the form of instructions executable by the processor 300 of the mobile communication device(s), and the process steps of the process 650 will thus be described below for purposes of this disclosure as being executed in part by the processor 50 of the main server 12 and in part by the processor 300 of the mobile communication device(s). It will be understood, however, that in some alternate embodiments, the part of the process 650 executed by the processor 50 of the main server may be alternatively stored, in whole or in part, in the memory 34 (and/or data storage 36) of the one or more of the local servers 22₁-22_{L} in the form of instructions executable, in whole or in part, by the processor 30 of one or more of the local servers 22₁-22_{L}, and in other embodiments this part of the process 650 may be stored, in whole or in part, in the memory 202 (and/or data storage 206) of the one or more of the POS systems 24₁-24_{M}, 24₁-24_{N} in the form of instructions executable, in whole or in part, by the processor 200 of one or more of the one or more of the POS systems 24₁-24_{M}, 24₁-24_{N}, and in still other embodiments which include one or more enterprise servers 26 as illustrated in FIG. 1, this part of the process 650 may be stored, in whole or in part, in a memory of the enterprise server(s) 26 in the form of instructions executable, in whole or in part, by a processor of the enterprise server(s) 26. In any such embodiments, the part of the process 650 indicated in FIG. 6B as being executed by the main server 12 may be executed in whole or in part by one or more processors within any one or a combination of the main server 12, any of the one or more local servers 22₁-22_{L}, any of the one or more of the POS systems 24₁-24_{M}, 24₁-24_{N} and the enterprise server(s) 26, wherein information may be shared between the such systems via wired and/or wireless connection.

In the embodiment illustrated in FIG. 6B, as with that illustrated in FIG. 6A, the MIP code is illustratively generated in a form that will be stored in, or accessed by, the customer's mobile communication device 16. As described hereinabove with respect to FIG. 6A, the MIP code stored in or accessed by the customer's mobile communication device 16 will then be automatically transferred from the mobile communication device 16 to the main server 12 during transactions for the purchase of one or more items from the retail enterprise 11 via one of the point-of-sale systems 24₁-24_{M}, 24₁-24_{N} in which an authorized EPS is to be automatically processed by the main server 12.

The process 650 illustrated in FIG. 6B begins at step 652 where the processor 50 of the main server 12 is operable to generate and include for display on the accessed customer's page of the EMS interface, or as a new page for display on the accessed customer's page of the EMS interface, a graphic user interface (GUI) prompting the customer to activate the MIP application 310 on the customer's mobile communication device 16. If the customer has not already activated the MIP application 310 on the customer's mobile communication device 16, the customer does so at step 654 in response to the prompt at step 652.

Following step 652, the processor 50 is operable at step 656 to generate and display code, e.g., a random, pseudo-random or other code, RC, and to instruct the customer to enter RC into a corresponding screen or field displayed or accessible on the customer's mobile communication device 16 as part of the MIP application 310. Thereafter at step 658, the customer is responsive to the instructions at step 656 to enter the code, RC, into the corresponding field or screen displayed on the customer's mobile communication device 16, and the processor 300 of the mobile communication device 16 is thereafter responsive at step 660 to such customer entry of the code, RC, to transmit the code, RC, and one or more additional data to the main server 12, which transmission is thereafter received by the processor 50 at step 662. The steps 656-660 are illustratively included in the process 650 to establish communication between the processor 50 and the processor 300, and to further establish the identity of the mobile communication device 16 with which the processor 50 is communicating. In this regard, the data which may accompany the code, RC, may be or include any information which establishes the identity of the customer within the EMS program and/or the identity of the mobile communication device 16 as one that is associated with the customer within the EMS program. Examples of such data may include, but are not limited to, one or more of the customer's EMSID, the customer's email address, the communication code, e.g., cellular telephone number, of the mobile communication device 16 with which the processor 50 is communicating, and the like.

Following receipt of the code, RC, (and, in some embodiments, any additional data) from the mobile communication device 16 at step 662, the processor 50 is operable at step 664 to generate an MIP code and to transmit the generated MIP code to the mobile communication device 16. After receipt by the mobile communication device 16 at step 666 of the generated MIP code transmitted by the processor 50, the processor 300 of the mobile communication device 16 is operable at step 668 to store the MIP code in the memory 304 or data storage 306, and/or in one or more off-board but otherwise accessible memories, for subsequent recall in a conventional manner. In the meantime, the processor 50 of the main server 12 is operable following step 664 to locate within the customer's EMS account, at step 670, the customer's EMSID and/or EPI of the authorized EPS, and thereafter at step 672 to store the generated MIP code in memory and associate the generated MIP code with the customer's EMSID and/or the EPI.

In one embodiment, the generated MIP code is stored by the processor 50 in the customer account data 404 of the database 402. In alternate embodiments, the MIP code may be stored, in whole or in part, elsewhere in one or more other databases or memory units within or outside of the system 10. The association between the MIP code and the customer's EMSID and/or the EPI of the authorized EPS may likewise be stored in the customer account data 404 of the database 402, although such association may in alternate embodiments be stored, in whole or in part, elsewhere in one or more other databases or memory units within or outside of the system 10. The MIP code itself may also be stored in the same database as the EPI and/or EMSID or may alternatively be stored, in whole or in part, in one or more other databases or memory units within our outside of the system 10. In any case, the processor 50 is illustratively operable to execute step 672 using any one or more conventional data association mechanisms, examples of which include, but are not limited to, a table, a chart, a linked list or other pointer, or the like.

It will be understood that the MIP code described above with respect to the processes 700 and 800 may be or include one or more combined codes as described with respect to the process 700 or may alternatively be or include a plurality of separate codes. In some embodiments, for example, the MIP code may be generated and stored as a single sequence of bits or characters, while in other embodiments the MIP code may be generated and stored in the form of two or more distinct and separate sequences of bits or characters. In one specific example, which should not be considered to be limiting in any way, the MIP code may be generated as a first sequence of bits that is or is a function of the customer's EMSID and a second, separate sequence of bits in the form of a security code that may or may not be a function of information relating to the customer, the customer's EMS account and/or the customer's mobile communication device 16.

Referring now to FIG. 7, a simplified flow diagram is shown depicting an embodiment of a process 700 for processing, during a transaction for the purchase by a customer of one or more items at one of the point-of-sale systems 24₁-24_{M}, 24₁-24_{N} of the retail enterprise 11, payment preferences established by the customer, e.g., established by the customer in the customer's EMS account using a process such as the process 500 illustrated and described with respect to FIG. 5, and for processing payment for the purchase transaction in accordance with the customer's established payment preferences. In one embodiment, the process 700 is stored in the memory 54 (and/or data storage 56) of the main server 12 in the form of instructions executable by the processor 50 of the main server 12, and the process steps of the process 600 will be described below for purposes of this disclosure as being executed by the processor 50 of the main server 12. It will be understood, however, that in some alternate embodiments, the process 700 may be alternatively stored, in whole or in part, in the memory 34 (and/or data storage 36) of the one or more of the local servers 22₁-22_{L} in the form of instructions executable, in whole or in part, by the processor 30 of one or more of the local servers 22₁-22_{L}, and in other embodiments the process 700 may be stored, in whole or in part, in the memory 202 (and/or data storage 206) of the one or more of the POS systems 24₁-24_{M}, 24₁-24_{N} in the form of instructions executable, in whole or in part, by the processor 200 of one or more of the one or more of the POS systems 24₁-24_{M}, 24₁-24_{N}, and in still other embodiments which include one or more enterprise servers 26 as illustrated in FIG. 1, the process 700 may be stored, in whole or in part, in a memory of the enterprise server(s) 26 in the form of instructions executable, in whole or in part, by a processor of the enterprise server(s) 26. In any such embodiments, the process 700 may be executed in whole or in part by one or more processors within any one or a combination of the main server 12, any of the one or more local servers 22₁-22_{L}, any of the one or more of the POS systems 24₁-24_{M}, 24₁-24_{N} and the enterprise server(s) 26, wherein information may be shared between the such systems via wired and/or wireless connection.

In embodiments in which the customer presents one or more items for purchase at a point-of-sale system 24₁-24_{M}, 24₁-24_{N} of the retail enterprise 11 and payment for such items is then processed by the main server 12 and/or the point-of-sale system 24₁-24_{M}, 24₁-24_{N} during or after the point-of-sale system 24₁-24_{M}, 24₁-24_{N} processes the one or more items, such as may typically occur during a purchase of one or more items at a brick-and-mortar outlet having a number of different types of items in inventory, the process 700 illustratively begins at step 702 which may include steps 704 and 706. At step 704, the customer presents one or more items for purchase at a point-of-sale system 24₁-24_{M}, 24₁-24_{N}, and step 706 the point-of-sale system 24₁-24_{M}, 24₁-24_{N} processes the one or more items in a conventional manner, e.g., by price scanning the one or more items, for purchase by the customer. In such embodiments, steps 704 and 706 may illustratively be concluded before advancing to the payment processing steps 712-726 of the process 700. In other embodiments, one or more of the payment processing steps 712-726 may be executed during the execution of step 704 and/or of step 706, and in such embodiments step 702 may therefore be inserted, in whole or in part, between one or more of the payment processing steps 712-726. In still other embodiments in which pre-payment or acceptance of a pre-payment instrument is required prior to delivery to the customer of one or more requested items, such as may occur, for example, when the requested item is fuel and the point-of-sale system 24₁-24_{M}, 24₁-24_{N} is a conventional fuel dispenser and/or a local/hub server 22₁-22_{L} of an associated fuel center and/or convenience store at which one or more such fuel dispensers is located, step 704 is typically executed prior to the payment processing steps 712-726 and step 706 is typically executed, i.e., by activating the fuel dispenser for dispensation of fuel, during or after the payment processing steps 712-726. In such embodiments, step 702 may thus be fragmented such that step 704 is executed prior to the payment process steps 712-726, i.e., when the customer requests one or more items for purchase at a point-of-sale system of the retail enterprise 11, and such that step 706 may be executed at any of various points within the payment processing steps 712-726 after pre-payment has been accepted or authorized by the main server 12 for the subsequently delivered product.

The process 700 further includes step 708 which, in the illustrated embodiment, is executed independently of step 702. In other embodiments, step 708 may be tied to step 702, e.g., such that step 708 is executed before or after step 702, or tied to either of steps 704 or 706, i.e., such that step 708 is executed before or after step 704 but is not otherwise tied to step 706, or such that step 708 is executed before or after step 706 but is not otherwise tied to step 704. In the embodiment illustrated in FIG. 7, step 708 is further executed prior to step 710. In embodiments which do not include step 710 or in which step 710 is executed elsewhere within the process 700, step 708 is executed prior to the payment processing steps 712-726. In any case, step 708 executes a mobile identification passcode or pin (MIP code) process in which the customer's mobile communication device 16 in which the previously generated MIP code, e.g., generated using a process such as that illustrated in FIG. 6A and/or 6B, is stored or to which the customer's mobile communication device 16 otherwise has access while the device 16 is carried by or proximate to the customer during the purchase transaction, is operable to detect identification signals wirelessly broadcast by the wireless signal broadcasting device 222 associated with the point-of-sale system 24₁-24_{M}, 24₁-24_{N}. The customer's mobile communication device 16 is further operable in the MIP process of step 708 to wirelessly communicate the detected identification of the wireless signal broadcasting device 222 to the main server 12. Further still, the customer's wireless communication device 16 and the main server 12 are operable in the MIP process 708 to thereafter wirelessly communicate and share information with each other, e.g., such as the MIP code, during which the processor 50 of the main server 12 is operable to determine the customer's payment preferences established by the customer, e.g., established by the customer in the customer's EMS account using a process such as the process 500 illustrated and described with respect to FIG. 5. The processor 50 is thereafter operable at steps 712-726 to process payment for the purchase transaction in accordance with the customer's established payment preferences. In embodiments that include step 710, the processor 50 is operable at step 708 to determine the customer's EMSID or other identifier of the customer's purchase history within the customer purchase history database 414, and is thereafter operable at step 710, wherever step 710 is located within the process 700, to automatically process the customer's EMSID or other identifier of the customer's purchase history within the customer purchase history database 414 to identify the customer's purchase history records or file within the database 414 and automatically update the customer's purchase history in the database 414 with information relating to the one or more items included in the current purchase transaction, i.e., in the purchase transaction being carried out according to the process 700.

Referring now to FIG. 8, one illustrative embodiment of a process 800 is shown for executing the MIP process of step 708 of the process 700. In the embodiment illustrated in FIG. 8, the MIP process 800 is an interactive process that takes place between the processor 50 of the server 12 and the processor 300 of a customer's mobile communication device 16. In this regard, the process 800 is illustratively one that is stored, in one embodiment, in-part in the memory 54 (and/or data storage 56) of the main server 12 in the form of instructions executable by the processor 50 of the main server 12 and in-part in the memory 304 or data storage 306 of the mobile communication device(s) in the form of instructions executable by the processor 300 of the mobile communication device(s), and the process steps of the process 800 will thus be described below for purposes of this disclosure as being executed in part by the processor 50 of the main server 12 and in part by the processor 300 of the mobile communication device(s). It will be understood, however, that in some alternate embodiments, the part of the process 800 executed by the processor 50 of the main server may be alternatively stored, in whole or in part, in the memory 34 (and/or data storage 36) of the one or more of the local servers 22₁-22_{L} in the form of instructions executable, in whole or in part, by the processor 30 of one or more of the local servers 22₁-22_{L}, and in other embodiments this part of the process 800 may be stored, in whole or in part, in the memory 202 (and/or data storage 206) of the one or more of the POS systems 24₁-24_{M}, 24₁-24_{N} in the form of instructions executable, in whole or in part, by the processor 200 of one or more of the one or more of the POS systems 24₁-24_{M}, 24₁-24_{N}, and in still other embodiments which include one or more enterprise servers 26 as illustrated in FIG. 1, this part of the process 800 may be stored, in whole or in part, in a memory of the enterprise server(s) 26 in the form of instructions executable, in whole or in part, by a processor of the enterprise server(s) 26. In any such embodiments, the part of the process 800 indicated in FIG. 800 as being executed by the main server 12 may be executed in whole or in part by one or more processors within any one or a combination of the main server 12, any of the one or more local servers 22₁-22_{L}, any of the one or more of the POS systems 24₁-24_{M}, 24₁-24_{N} and the enterprise server(s) 26, wherein information may be shared between the such systems via wired and/or wireless connection.

The process 800 begins at step 802 where the wireless signal broadcasting device(s) 222 associated with, i.e., positioned at, near, on or part of, the point-of-sale system 24₁-24_{M}, 24₁-24_{N} at which the current purchase transaction is being conducted is/are operable, as described hereinabove with respect to FIG. 2, to broadcast, e.g., periodically and continually, one or more unique wireless identification signals, i.e., identification signals that distinguish the particular wireless signal broadcasting device(s) from wireless signal broadcasting devices associated with other point-of-sale systems 24₁-24_{M}, 24₁-24_{N} within the retail enterprise 11 and from other wireless signal broadcasting devices located within the brick-and-mortar outlet or store within which the wireless signal broadcasting device(s) 222 is/are located. In some embodiments, one or more of the wireless signal broadcasting devices 222 may broadcast the unique wireless identification signals non-periodically, and/or may broadcast unique wireless identification signals non-continually but rather only upon detection of a nearby customer mobile communication device 16, e.g., via detection by the communication circuitry 210 of the corresponding point-of-sale system 24 of one or more short-range wireless signals produced by the customer mobile communication device 16, via proximity detection of the customer and/or customer mobile communication device 16 using a suitable proximity sensor included in the peripheral devices 212 of the corresponding point-of-sale system 24, or the like. In any case, at some point while the wireless signal broadcasting device(s) 222 is/are broadcasting the one or more unique wireless signals, the customer, carrying the customer's mobile communication device 16, approaches the point-of-sale system 24₁-24_{M}, 24₁-24_{N} to commence the current purchase transaction. This scenario is depicted in FIG. 9 which illustrates one such wireless signal broadcasting device 222, mounted to or near the point-of-sale system 24, periodically broadcasting unique wireless signals, which are represented by the semi-circular dashed lines emanating from the wireless signal broadcasting device 222.

The point of sale system 24 is communicatively coupled to the main server 12 via the private network 20 and, in the illustrated embodiment, via the local hub server 22. In the embodiment illustrated in FIG. 9, the point-of-sale system 24 and local hub server 22 are those at which the current purchase transaction is being conducted. The customer's mobile communication device 16 and the main server 12 are each configured to communicate wirelessly with each other via the public network 14. In some embodiments, each brick-and-mortar location of the retail enterprise 11 may include one or more local or wide area networks for the purpose of providing communication access by mobile communication devices 16₁-16_{J} to the public network 14 from within the brick-and-mortar outlet via one or more wireless access points. In any case, as the customer's mobile communication device 16 approaches the point-of-sale system 24, the customer's mobile communication device 16 enters the broadcast range of the wireless signal broadcasting device 222 as depicted in FIG. 9. When within the broadcast range of the wireless signal broadcasting device 222, the mobile communication device 16 is able to detect the unique identification signals being periodically broadcast by the wireless signal broadcasting device 222. Illustratively, the broadcast range of the wireless signal broadcasting device is sufficiently large, wide and/or oriented to be detected by customers' mobile communication devices 16 during the normal processing by the point-of-sale system 24 of one or more items being purchased, e.g., such processing including receipt, transport, price scanning and/or bagging of purchased items, while is at the same time sufficiently small, narrow and/or oriented so as not to be detected by mobile communication devices 16₁-16_{J} of customers being processed by one or more adjacent point-of-sale systems 24₁-24_{M}, 24₁-24_{N}.

Referring again to FIG. 8, the customer's mobile device 16 is operable at step 804 to detect the unique identification signals wirelessly broadcast by the wireless signal broadcasting device 222 associated with the point-of-sale system 24 at which the current purchase transaction is being processed when the customer's mobile communication device 16 is within the broadcast range of the wireless signal broadcasting device 222 as illustrated by example in FIG. 9. Thereafter at step 806, the processor 300 of the customer's mobile communication device 16 is illustratively responsive to such detection of the unique identification signals broadcast by the wireless signal broadcasting device 222 to wake up and activate the MIP application 310 stored in the memory 304 or data storage 306 of the mobile communication device 16 (or stored in off-board storage that is accessible to the mobile communication device 16). For the remainder of the process 800, the processor 300 of the customer′ mobile communication device 16 is operable to execute the device's 16 portion of the process 800 according to the MIP application 310, i.e., the processor 300 of the customer's mobile communication device is operable to execute the instructions contained in the MIP application 310 to execute the remainder to the process 800.

Following step 806, the process 800 advances, in one embodiment of the process 800, to step 808 where the processor 300 of the customer's mobile communication device 16 is operable to transmit one or more wireless signals to the main server 14, e.g., via the public network 14 as illustrated in FIG. 9. The one or more wireless signals contain(s) the unique identification (UID) of the wireless signal broadcasting device 222 and also illustratively contain(s) an identification of the customer's mobile communication device 16. The identification of the customer's mobile communication device 16 may be, for example, the communication code, e.g., cellular telephone number and/or other communication identifier, which identifies the customer's mobile communication device 16 to the main server 12 for the purpose of communicating information from the main server 12 back to the customer's mobile communication device 16. In one embodiment, the processor 300 of the customer's mobile communication device 16 is operable at step 808 to process one or more of the unique identification signals wirelessly broadcast, e.g., periodically, by the wireless signal broadcasting device 222 and detected by the customer's mobile communication device 16 to determine therefrom the UID of the wireless signal broadcasting device 222 and to include the UID of the wireless signal broadcasting device in the one or more wireless signals transmitted by the mobile communication device 16 to the main server at step 808. In other embodiments, the processor 300 is operable at step 808 to process one or more of the unique identification signals wirelessly broadcast, e.g., periodically, by the wireless signal broadcasting device 222 and detected by the customer's mobile communication device 16 to include in the UID transmitted by the mobile communication device 16 to the main server at step 808 only the raw signal content of one or more of the unique identification signals broadcast by the wireless signal broadcasting device 222. In such embodiments, the processor 50 of the main server 12 may be operable to thereafter process the raw signal content transmitted thereto by the customer's mobile communication device 16 to determine therefrom the UID of the wireless signal broadcasting device 222.

Following step 808, the main server 12 is operable at step 810 to receive the one or more wireless signals transmitted by the customer's mobile communication device 16 at step 808, and the processor 50 is operable at step 810 to process the UID contained therein to determine the corresponding one of the point-of-sale systems 24₁-24_{M}, 24₁-24_{N} with which the wireless signal broadcasting device 222 detected by the customer's mobile communication device 16 is associated, i.e., at which the wireless signal broadcasting device 222 is located. As described briefly above with respect to FIG. 4, the wireless signal broadcasting device module 434 of the main server 12 illustratively has stored therein, and/or stored within the database 402, the wireless signal broadcasting device identity information for each wireless signal broadcasting device 222 in the retail enterprise 11 as well as additional information from which the processor 50 can determine and identify, for each wireless signal broadcasting device 222 located at one of the point-of-sale systems 24₁-24_{M}, 24₁-24_{N}, the particular point-of-sale system 24₁-24_{M}, 24₁-24_{N} at which each such wireless signal broadcasting device 222 is located. In one embodiment, for example, the wireless signal broadcasting device identity information is or includes the UIDs for each wireless signal broadcasting device located at one of the point-of-sale systems 24₁-24_{M}, 24₁-24_{N}, and each such UID includes or is associated with, e.g., linked to, mapped to, or otherwise identified with, a POS identifier (POSID), e.g., in the form of a designation number or code, which identifies the corresponding one of the point-of-sale systems 24₁-24_{M}, 24₁-24_{N} at which the wireless signal broadcasting device 222 is located. In such embodiments, the processor 50 is illustratively operable at step 810 to process the UID by searching for a matching UID stored in the wireless signal broadcasting device module 434 and determining the POSID associated in the module 434 with the matched UID to determine the identity of the corresponding one of the point-of-sale system 24₁-24_{M}, 24₁-24_{N} at which the current purchase transaction is taking place.

In other embodiments, the UID of each wireless signal broadcasting device 222 located at one of the point-of-sale systems 24₁-24_{M}, 24₁-24_{N} is associated in the wireless signal broadcasting device module 434 with a unique wireless signal broadcasting device location (UBL). In such embodiments, the unique wireless signal broadcasting device locations, UBL, are stored in the module 434 and associated in the module 434 with, e.g., linked to, mapped to or otherwise identified with, the UID of a corresponding wireless signal broadcasting device 222. In one embodiment, the unique wireless signal broadcasting device locations, UBL, may illustratively include, or be mapped to, location coordinates relative to one or more sets of base coordinates of a corresponding one of the brick-and-mortar stores or outlets of the retail enterprise 11. In such embodiments, the locations of each of point-of-sale system 24₁-24_{M}, 24₁-24_{N} of the retail enterprise 11 may likewise be stored in the database 412 also in the form of location coordinates relative to the one or more sets of base coordinates of the corresponding brick-and-mortar stores or outlets. In such embodiments, the processor 50 is illustratively operable at step 810 to process the UID by searching for a matching UID stored in the database 402 and comparing the location coordinates associated with the matched UID with those of the point-of-sale systems 24₁-24_{M}, 24₁-24_{N} stored in the database 402 to determine the identity of the corresponding one of the point-of-sale system 24₁-24_{M}, 24₁-24_{N} at which the current purchase transaction is taking place.

In either of the foregoing embodiments, the UID contained in the wireless signals broadcast by the wireless signal broadcasting devices 222 may further include a wireless signal broadcasting device type (BT), and the wireless signal broadcasting device identity information stored in the wireless signal broadcasting device module 434 may likewise include, or be mapped to, corresponding wireless signal broadcasting device type information. Illustratively, the wireless signal broadcasting device identity information of the various wireless signal broadcasting devices 222 stored in the wireless signal broadcasting device module 434 may, in such embodiments, be stored according to wireless signal broadcasting device type, e.g., such that the wireless signal broadcasting device identity information stored in the wireless signal broadcasting device module 434 is or can be categorized by wireless signal broadcasting device type. The wireless signal broadcasting device type may illustratively be or include an indicator of the general location or use of the wireless signal broadcasting device 222, and example wireless signal broadcasting device types may include, but should not be limited to, point-of-sale wireless signal broadcasting devices, brick-and-mortar location entrance wireless signal broadcasting devices, wireless signal broadcasting devices associated with specific departments or product category locations within the retail enterprise 11, general store location wireless signal broadcasting devices, or the like. In such embodiments, the processor 50 is illustratively operable at step 810 to process the UID received from the customer's mobile communication device 16 by first determining the wireless signal broadcasting device type, BT, of the wireless signal broadcasting device 222 detected by the customer's mobile communication device 16, e.g., from the BT included in or appended to the UID received from the customer's mobile communication device 16, then searching for a matching UID stored in the wireless signal broadcasting device module 434 only among the stored wireless signal broadcasting device identity information having wireless signal broadcasting device types that match BT, and then proceeding as described above with respect to a matched UID. Those skilled in the art will recognize additional or alternative information that may be included in, with and/or appended to the UID, and/or additional or alternative information about the retail location 11 and the infrastructure of its various brick-and-mortar stores or outlets that may be collected and stored or otherwise be made accessible to the main server 12, which the processor 50 of the main server 12 may be configured and operable to process at step 810 to determine the identity and/or location of the one of the point-of-sale systems 24₁-24_{M}, 24₁-24_{N} at which the current purchase transaction is taking place. It will be understood that any such additional or alternate forms of information are contemplated by this disclosure.

Further at step 810, the processor 50 of the main server is operable to process the communication information included in or with the wireless signal(s) transmitted by the customer's mobile communication device 16 at step 808 to determine the identity of the customer's mobile communication device 16 for purposes of wirelessly transmitting information thereto, e.g., via the public network 14.

Following step 810, the processor 50 of the main server 12 is operable at step 812 to determine whether a matching UID was found, e.g., in the wireless signal broadcasting device module 434, at step 810. Generally, if the processor 50 is unable to locate a matching UID at step 810, this means that the wireless signal broadcasting device 222 detected by the customer's mobile communication device 16 is not associated with any of the point-of-sale systems 24₁-24_{M}, 24₁-24_{N} of the retail enterprise 11, i.e., is not a POS wireless signal broadcasting device 222, or that there were one or more errors in receiving, processing and/or transmitting one or more wireless signals by the customer's mobile communication device 16, the main server 12 and/or the network 14. It will be understood that the process 800 may be modified to include one or more conventional diagnostic processes for processing and addressing any such one or more errors, including for example re-executing one or more of the steps 802-810, and that any such modifications are contemplated by this disclosure. Those skilled in the art will recognize that any such modifications to the process 800 would be a mechanical step for a skilled software programmer. If the processor 50 determines at step 812 that the wireless signal broadcasting device 222 detected by the customer's mobile communication device 16 is not associated with any of the point-of-sale systems 24₁-24_{M}, 24₁-24_{N} of the retail enterprise 11, the process 800 follows the NO branch of step 812 and terminates without returning any information which would allow the process 700 illustrated in FIG. 7 to execute any of the auto-clip, auto-credit or auto-pay steps 714-724.

If, at step 812, the processor 50 of the main server 12 determines that the wireless signal broadcasting device 222 detected by the customer's mobile communication device 16 is associated with an identified one of the point-of-sale systems 24₁-24_{M}, 24₁-24_{N} of the retail enterprise 11, the process 800 advances to step 814 where the processor 50 of the main server 12 is operable to transmit an MIP request signal back to the customer's mobile communication device 16, i.e., back to a communication recipient address, number or code of the customer's mobile communication device 16 identified by the processor 50 based on the communication code included in or with the wireless signal(s) transmitted by the customer's mobile communication device 16 at step 808. Illustratively, the MIP request signal is or contains a request or instruction by the processor 50 to the customer's mobile communication device 16 to transmit the MIP code stored therein or accessible thereto, e.g., created according to the process 600 and/or 650 illustrated and described with respect to FIGS. 6A and 6B respectively. At step 816, the customer's mobile communication device 16 receives the MIP request signal, and thereafter at step 818 the processor 300 of the customer's mobile communication device 16 is operable to access the MIP code stored therein or otherwise accessible thereto, and to transmit the MIP code to the main server 12.

In some embodiments, the process steps 808-818 just described may be replaced by step 820, as shown in dashed outline, to which the process 800 advances following execution of step 806 (in which the processor 300 of the mobile communication device 16 has awoken and activated the MIP application 310 in response to detection of one or more unique identification signals broadcast by the wireless signal broadcasting device 222). In some such embodiments, the memory 304 and/or data storage 306 of the customer's mobile communication device 16 illustratively has wireless signal broadcasting device information stored therein, as part of the MIP application 310, which relates to some or each of the various wireless signal broadcasting devices in one or more of the brick-and-mortar outlets or stores of the retail enterprise 11. In one embodiment in which the UID includes or has appended thereto a wireless signal broadcasting device type, BT, the wireless signal broadcasting device information stored in the customer's mobile communication device 16 illustratively is or includes wireless signal broadcasting device type information which identifies different wireless signal broadcasting device types, e.g., POS wireless signal broadcasting devices, brick-and-mortar stored entrance wireless signal broadcasting devices, etc. as described above. In such embodiments, the processor 300 is operable at step 822 to process the unique identification signals broadcast by the wireless signal broadcasting device 222 to determine the UID of the wireless signal broadcasting device 222, to then process the UID to determine the wireless signal broadcasting device type, BT, of the wireless signal broadcasting device 222, and to then compare BT to the stored wireless signal broadcasting device information to determine whether the wireless signal broadcasting device 222 is a POS wireless signal broadcasting device. If so, the processor 300 is operable at step 824 to access the MIP code stored therein or otherwise accessible thereto, and to then transmit the MIP code and the UID of the wireless signal broadcasting device 222 to the main server 12. Otherwise, the process 800 terminates without returning any information which would allow the process 700 illustrated in FIG. 7 to execute any of the auto-clip, auto-credit or auto-pay steps 714-724, as shown by the dashed line extending from step 820 to DONE in FIG. 8.

In other embodiments that include step 820, the wireless signal broadcasting device information stored in the customer's mobile communication device 16 illustratively is or includes information that links, maps or otherwise associates wireless signal broadcasting device UIDs of at least the wireless signal broadcasting devices 222 at some or all of the brick-and-mortar outlets of the retail enterprise 11 to identifiers of the point-of-sale systems 24₁-24_{M}, 24₁-24_{N} at which they are located, e.g., POSIDs. In such embodiments, the processor 300 is operable at step 822 to process the unique identification signals broadcast by the wireless signal broadcasting device 222 to determine the UID of the wireless signal broadcasting device 222, and to then compare the UID to the stored wireless signal broadcasting device information to identify the POSID of the particular one of the point-of-sale systems 24₁-24_{M}, 24₁-24_{N} at which the wireless signal broadcasting device 222 is located. If the comparison made by the processor 300 at step 822 produces a valid POSID, the processor 300 is thereafter operable at step 824 to access the MIP code stored therein or otherwise accessible thereto, and to then transmit the MIP code along with the POSID to the main server 12. If the comparison made by the processor 300 at step 822 does not produce a POSID, or in some embodiments a valid POSID, the process 800 terminates without returning any information which would allow the process 700 illustrated in FIG. 7 to execute any of the auto-clip, auto-credit or auto-pay steps 714-724, as shown by the dashed line extending from step 820 to DONE in FIG. 8.

In still other embodiments that include step 820, the wireless signal broadcasting device information acted upon by the processor 300 of the customer's mobile communication device 16 at step 822 is not stored in the memory 304 and/or data storage 306, but is rather stored elsewhere or transmitted to or otherwise made accessible to the customer's mobile communication device 16 by the main server 12 according to a store identification process that is triggered by activation of the MIP application 310 in response to detection of one or more unique identification signals broadcast by the wireless signal broadcasting device 222 at step 804. In such embodiments, the store identification process is illustratively an interactive process between the processor 300 of the customer's mobile communication device 16 and the processor 50 of the main server in which the processor 300 of the customer's mobile communication device 16 is operable upon activation of the MIP application 310 to transmit a location identification signal to the main server 12 indicative of a current location of the customer's mobile communication device 16. In one embodiment, the location signal includes the current or most recent GPS coordinates of the customer's mobile communication device 16, and the processor 50 of the main server 12 is operable to identify the specific one of the brick-and-mortar outlets or stores of the retail enterprise 11 at which the customer's mobile communication device 16 is currently located, e.g., by comparing such coordinates to known coordinates of the various brick-and-mortar outlets or stores of the retail enterprise 11 that are stored in the database 402 or other database. In other embodiments, the location signal transmitted by the customer's mobile communication device 16 may not include any specific information relating to the coordinates of the customer's mobile communication device 16, but may rather include information relating to the identity of the LAN or WAN implemented in the particular brick-and-mortar outlet or store in which the customer's mobile communication device 16 is currently located and which is used by the customer's mobile communication device 16 to access the public network 14 in order to transmit the signal. In such embodiments, the processor 50 of the main server 12 may be operable to process the location signal to determine the specific one of the brick-and-mortar outlets or stores of the retail enterprise 11 at which the customer's mobile communication device 16 is currently located, e.g., by comparing the information in or carried by the location signal relating to the LAN or WAN used by the customer's mobile communication device 16 to access the network 14 with known LAN or WAN information stored in the database 402 or other database to determine the store or outlet in which the transmitting LAN or WAN is located. In any case, following identification of the specific brick-and-mortar outlet or store in which the customer's mobile communication device 16 is currently located, the processor 50 of the main server 12 is operable in one embodiment to transmit to the customer's mobile communication device 16 the wireless signal broadcasting device information relating only to the wireless signal broadcasting devices in the identified brick-and-mortar outlet or store. In other embodiments, the processor 50 of the main server 12 is operable to provide access by the processor 300 of the customer's mobile communication device 16 to such wireless signal broadcasting device information stored in the wireless signal broadcasting device module 434 or database 402 (or other database) so that the processor 300 may thereafter process such wireless signal broadcasting device information as described above.

In any case, the process 800 advances from step 818, in embodiments that include steps 808-818, or from step 824 in embodiments that include step 820, to step 826 where the processor 50 of the main server 12 is operable to receive the MIP code transmitted by the customer's mobile communication device 16. In some embodiments that include step 820, the MIP code transmitted by the customer's mobile communication device 16 may be accompanied by the UID of the wireless signal broadcasting device 222 and in other such embodiments the MIP code may be accompanied by the POSID of the particular one of the point-of-sale systems 24₁-24_{M}, 24₁-24_{N} at which the wireless signal broadcasting device 222 is located. In the former case, the processor 50 of the main server 12 is further operable at step 826 to process the UID of the wireless signal broadcasting device 222 to determine the POSID of the particular one of the point-of-sale systems 24₁-24_{M}, 24₁-24_{N} at which the wireless signal broadcasting device 222 is located, as described hereinabove with respect to step 810.

Following step 826, the processor 50 of the main server 12 is operable at step 828 to determine whether the MIP code transmitted to the main server 12 by the customer's mobile communication device 16 matches an MIP code stored in one or more databases, i.e., whether the MIP code matches a corresponding MIP code of one of the shopper members of the EMS program. The processor 50 is illustratively operable to execute step 828 of the process 800 by searching for the MIP code in the EMS account data 404 in embodiments in which the MIP codes are stored in the EMS accounts data 404, or in one or more other databases in which MIP codes are stored. If a matching MIP code is found at step 828, the process 800 advances to step 830 where the processor 50 is operable to identify, in the database 402 or other database, one or more codes or other information that is associated with, e.g., stored with, mapped to or linked to, the matching MIP code in the database 402 or other database which the processor 50 may then use to process the purchase transaction currently underway at the identified point-of-sale system 24 according to the purchase transaction preferences established by the corresponding customer member of the EMS program. In one embodiment, the processor 50 is operable at step 830 to identify the enterprise membership identification, EMSID, as the code associated with the matching MIP code, which thus identifies the EMS account of the customer member conducting the current purchase transaction. In other embodiments, the processor 50 may be operable at step 830 to identify one or more other codes or other information associated in the database 402 or other database with the matching MIP, and in such embodiments the processor 50 may use such one or more other codes or other information to identify the EMS account of the customer member and/or to identify specific information associated with the EMS account, e.g., the authorized EPS, etc. In some embodiments, the MIP code or some portion thereof may be or include the code identified at step 830, and in such embodiments the processor 50 need not search the database 402 or other database to determine the identified code. In any case, following step 830, the process 800 is complete and the process step 708 illustrated in FIG. 7 returns the identified code associated with the MIP code transmitted to the main server 12 by the customer's mobile communication device 16, e.g., the EMSID of the customer conducting the current purchase transaction at the identified one of the point-of-sale systems 24₁-24_{M}, 24₁-24_{N}. If, at step 828, the processor 50 determines that none of the one or more databases in which MIP codes are stored has stored therein an MIP code that matches the MIP code transmitted to the main server 12 by the customer's mobile communication device 16, the process 800 terminates without returning any information which would allow the process 700 illustrated in FIG. 7 to execute any of the auto-clip, auto-credit or auto-pay steps 714-724, as shown by the arrowed line extending from step 828 to DONE in FIG. 8.

It will be understood that the MIP code described above with respect to the processes 700, 750 and 800 may be or include one or more combined or separate codes as described with respect to the process 700. It will be further understood that while the process 800 has been described in the context of transmitting, receiving and searching one or more databases for an MIP code, nothing in this disclosure is intended to limit such an MIP code to a single sequence of bits or characters. In some embodiments, for example, the MIP code may be implemented as a single sequence of bits or characters, while in other embodiments the MIP code may be implemented in the form of two or more separate, and in some cases separately transmitted and received, sequences of bits or characters. As one specific example of the latter implementation, which should not be considered limiting in any way, the MIP code may include a first MIP code in the form of, e.g., the customer's EMSID or coded version thereof, and a second MIP code in the form of, e.g., a random or otherwise generated security code, which is separate and distinct from the first MIP code and which is transmitted and received separately from the first MIP code. In some embodiments, the customer's mobile communication device 16 may be operable to transmit such multiple MIP codes codes, or to transmit a single MIP code in multiple wireless signal transmissions, without interruption by or data requests by the processor 50 of the main server 12. In some alternative embodiments, the customer's mobile communication device 16 may be operable to transmit such multiple MIP codes, or to transmit a single MIP code in multiple wireless signal transmissions, by executing one or more of the multiple signal transmissions in response to one or more requests transmitted by the processor 50 to the customer's mobile communication device 16. In other alternative embodiments, the customer's mobile communication device 16 may be operable to transmit such multiple MIP codes, or to transmit a single MIP code in multiple wireless signal transmissions, by executing one or more of the multiple signal transmissions in response to one or more acknowledgements transmitted by the processor 50 to the customer's mobile communication device 16 of one or more data transmission notifications previously transmitted by the customer's mobile communication device 16.

In any case, it will be further understood that in embodiments in which the MIP code, whether in the form of a single transmitted/received signal or multiple, separate transmitted/received signals, includes two or more codes, the processor 50 will be operable at step 828 to determine whether the MIP code transmitted to the main server 12 by the customer's mobile communication device 16 matches an MIP code stored in one or more databases by comparing each such transmitted/received code with codes stored in the database 402 or other database, and that a determination by the processor 50 that the MIP code matches an MIP code stored in one or more databases requires a match for each code contained in the MIP code. As an example in which the MIP code includes an EMSID and a security code, a determination by the processor 50 at step 828 that the MIP code transmitted to the main server 12 by the customer's mobile communication device 16 matches an MIP code stored in one or more databases will require a match between the transmitted EMSID and one of the plurality of EMSIDs stored in one or more databases as well as a match between the transmitted security code and a corresponding security code stored in the one or more databases and associated in the one or more databases with the matching EMSID.

Referring again to FIG. 7, the process advances from step 708 to step 709 where the processor 50 is operable to determine whether the MIP process executed at step 708 returned an identified code, e.g., the enterprise membership identification, EMSID, of the customer conducting the purchase transaction at the identified one of the point-of-sale systems 24₁-24_{M}, 24₁-24_{N}. If not, the process advances to step 726 where the processor 50 is operable to process payment for the purchase transaction being carried out at the identified one of the point-of-sale systems 24₁-24_{M}, 24₁-24_{N} in a conventional manner, i.e., via cash, check or a tangible form of electronic payment, e.g., credit card, debit card or the like. If, at step 709 the processor 50 determines that the MIP process executed at step 708 returned an identified code, the process 700 advances to step 710 where the processor 50 is operable to update the purchase history associated with the identified code with the one or more items processed, or being processed, by the identified point-of-sale system 24₁-24_{M}, 24₁-24_{N}, i.e., the one or more items presented or requested at step 704 of the process 700. Illustratively, the processor 50 is operable at step 710 to update the purchase history associated with the identified code by adding all or part of the information about each of the one or more items to the customer purchase history data 414 associated with the identified code. Such information may be or include any of the item/product information described above with respect to FIG. 4.

The process 700 advances from step 710 to step 712 where the processor 50 is operable to determine whether the customer has previously elected to activate the auto-pay feature described above, e.g., by identifying in the customer's EMS account, such as via the process 500 illustrated and described herein, electronic payment information, EPI, of a specified electronic payment system, EPS, for automatic payment for items subsequently purchased by the customer at one of the point-of-sale systems 24₁-24_{M}, 24₁-24_{N} of the retail enterprise 11. In the embodiment of the process 700 illustrated in FIG. 7, the processor 50 is operable to execute step 712 by determining whether the EPI flag associated with the identified EMSID in the customer account data 404 is set. If so, the process 700 advances to step 714, and otherwise the process 700 advances to step 726 where the processor 50 is operable to process payment for the purchase transaction being carried out at the identified one of the point-of-sale systems 24₁-24_{M}, 24₁-24_{N} in a conventional manner.

At step 714, the processor 50 of the main server 12 is operable to determine whether the customer has previously elected to activate the auto-clip feature described above. In the embodiment of the process 700 illustrated in FIG. 7, the process 50 is operable to execute step 714 by determining whether the auto-clip flag associated with the identified code in the customer account data 404 is set. If so, the customer has previously elected to activate the auto-clip feature described above, and the process 700 advances to step 716 where the processor 50 is operable to apply the discount amount of any virtual coupon contained in the virtual coupon bank 408 to the price of a matching item processed by the identified one of the point-of-sale systems 24₁-24_{M}, 24₁-24_{N} in the current purchase transaction. If, at step 714, the processor 50 determines that the auto-clip flag is not set, the process 700 advances to step 718 where the processor 50 is operable to apply the discount amount of any virtual coupon in the customer's clipped virtual coupon repository 410, i.e., those virtual coupons previously clipped by the customer, to the price of a matching item processed by the identified one of the point-of-sale systems 24₁-24_{M}, 24₁-24_{N} is the current purchase transaction.

Following either of step 716 and 718, the process 700 advances to step 720 where the processor 50 of the main server 12 is operable to determine whether the customer has previously elected to activate the auto-credit feature described above. In the embodiment of the process 700 illustrated in FIG. 7, the process 50 is operable to execute step 716 by determining whether the credit flag associated with the identified code in the customer account data 404 is set. If so, the customer has previously elected to activate the auto-credit feature described above, and the process 700 advances to step 722 where the processor 50 is operable to apply the credit amount in the customer's credit repository 412 that was previously designated by the customer, e.g., via the process 500 described above, to the total price of the purchase transaction being conducted by the identified one of the point-of-sale systems 24₁-24_{M}, 24₁-24_{N} or to the price of one or more items and/or item categories previously designated by the customer. If, at step 720, the processor 50 determines that the credit flag is not set, or following execution of step 722, the process 700 advances to step 724 where the processor 50 is operable to identify the electronic payment information, EPI, associated with the identified code, and to then process payment for the purchase transaction using the electronic payment information, EPI, associated with the identified code.

It should now be apparent from the foregoing that the systems and methods described in this disclosure provide for the pre-authorization by a customer of an electronic payment system, EPS, in a customer's retail enterprise membership services account to be automatically processed for payment for subsequent purchases made by the customer at point-of-sale systems of the retail enterprise, and further provide for one or more codes to be pre-stored in the customer's mobile communication device which will be automatically processed for payment for such subsequent purchases without any action required by the customer. It will be understood that while such systems and methods have been illustrated and described herein in the form of example embodiments that include the use of one or more flags, such flags have been included only for the purpose of facilitating the description of such systems and methods and that any such flags may but need not be implemented as part of any process described herein.

Embodiments of the processes 700 and 800 have been illustrated and described herein in which the customer's mobile communication device 16 and the main server 12 communicate wirelessly, e.g., via the public network 14, in relation to providing wireless signal broadcasting device information to the main server 12 by the customer's mobile communication device 16 resulting from detection of at least one of the unique wireless signals periodically broadcast by the one or more wireless signal broadcasting devices 222, and in relation to receipt by the main server 12 from the customer′ mobile communication device 16 of the MIP code. In some alternative embodiments, the customer's mobile communication device 16 may alternatively conduct any such wireless communications with the point-of-sale system 24₁-24_{M}, 24₁-24_{N} processing the customer's current purchase transaction, i.e., between the processors 200 and 300 via the respective communication circuits 210 and 312. In such embodiments, the point-of-sale system 24₁-24_{M}, 24₁-24_{N} processing the customer's current purchase transaction may be operable to communicate information received from the customer's mobile communication device 16 to the main server 12 via, e.g., the private network 20, and the main server 12 may likewise be operable to communicate information to the customer's mobile communication device 16 by providing such information to the point-of-sale system 24₁-24_{M}, 24₁-24_{N} processing the customer's current purchase transaction, e.g., via the private network 20, with the point-of-sale system 24₁-24_{M}, 24₁-24_{N} processing the customer's current purchase transaction then transmitting such information to the customer's mobile communication device 16. In such embodiments in which the point-of-sale system 24₁-24_{M}, 24₁-24_{N} processing the customer's current purchase transaction is coupled to one of the local hub servers 22₁-22_{L}, that local hub server 22 is illustratively operable to pass any such communications between the main server 12 and the point-of-sale system 24₁-24_{M}, 24₁-24_{N} processing the customer's current purchase transaction. In such embodiments that do not include any such local hub server 22, such communications may take place directly between the main server 12 and the point-of-sale system 24₁-24_{M}, 24₁-24_{N} processing the customer's current purchase transaction.

In other alternative embodiments in which the point-of-sale system 24₁-24_{M}, 24₁-24_{N} processing the customer's current purchase transaction is coupled to one of the local hub servers 22₁-22_{L}, the customer's mobile communication device 16 may alternatively conduct any such wireless communications with the local hub server 22 coupled to the point-of-sale system 24₁-24_{M}, 24₁-24_{N} processing the customer's current purchase transaction, i.e., between the processors 30 and 300 via the respective communication circuits 38 and 312. In such embodiments, the local hub server 22 may be operable to communicate information received from the customer's mobile communication device 16 to the main server 12 via, e.g., the private network 20, and the main server 12 may likewise be operable to communicate information to the customer's mobile communication device 16 by providing such information to the local hub server 22, e.g., via the private network 20, with the local hub server 22 then transmitting such information to the customer's mobile communication device 16.

In still other alternative embodiments in which the point-of-sale system 24₁-24_{M}, 24₁-24_{N} processing the customer's current purchase transaction may or may not be coupled to one of the local hub servers 22₁-22_{L} but in which the main server 12 is coupled to one or more enterprise servers 26, the customer's mobile communication device 16 may alternatively conduct any such wireless communications with at least one of the one or more enterprise servers 26 e.g., via the public network 14. In such embodiments, the at least one enterprise server 26 may be operable to communicate information received from the customer's mobile communication device 16 to the main server 12 via, e.g., a private network, and the main server 12 may likewise be operable to communicate information to the customer's mobile communication device 16 by providing such information to the at least one enterprise server 26 with the at least one enterprise server 26 then transmitting such information to the customer's mobile communication device 16.

In further alternative embodiments which may include one or more of the local hub servers 22₁-22_{L} and/or one or more enterprise servers 26, the customer's mobile communication device 16 may alternatively conduct any such wireless communications with any one or combination of the point-of-sale system 24₁-24_{M}, 24₁-24_{N} processing the customer's current purchase transaction, a local hub server 22 coupled thereto and/or at least one enterprise server 26 coupled to the main server 12. In such embodiments, the customer's mobile communication device 16 and the main server 12 may be operable to conduct wireless communications through such one or any combination of the point-of-sale system 24₁-24_{M}, 24₁-24_{N} processing the customer's current purchase transaction, a local hub server 22 coupled thereto and/or at least one enterprise server 26 coupled to the main server 12.

In still further alternative embodiments in which one or more portions of the process 700 and/or 800 executed by the processor 50 is executed by at least one processor of one or any combination of the point-of-sale system 24₁-24_{M}, 24₁-24_{N} processing the customer's current purchase transaction, a local hub server 22 coupled thereto and/or at least one enterprise server 26 coupled to the main server 12, the customer's mobile communication device 16 may alternatively conduct any such wireless communications with any one or combination of the point-of-sale system 24₁-24_{M}, 24₁-24_{N} processing the customer's current purchase transaction, a local hub server 22 coupled thereto, the main server 12 and/or at least one enterprise server 26 coupled to the main server 12.

While the disclosure has been illustrated and described in detail in the drawings and foregoing description, such an illustration and description is to be considered as exemplary and not restrictive in character, it being understood that only illustrative embodiments have been shown and described and that all changes and modifications consistent with the disclosure and recited claims are desired to be protected. For example, it will be understood that while several process steps in various sequences have been illustrated and described herein with respect to the processes 500, 600, 650, 700 and 800, any one or more such processes 500, 600, 650, 700 and 800 may alternatively include more, fewer and/or different steps, and that any such steps may be executed in different sequences from those illustrated and described, without departing from the scope of the concepts and techniques described herein.

In the embodiments described herein, the position identification devices (PIDs) 222 have been described as being implemented as wireless signal broadcasting devices, e.g., conventional radio frequency broadcasting beacons, configured to broadcast wireless signals each containing a UID. In some alternate embodiments, one or more of the PIDs may be implemented as wireless signal transceivers configured to can broadcast and receive wireless signals and/or as wireless signal receivers configured to receive broadcast wireless signals, e.g., broadcast by a mobile communication device or other device and, in some cases, to communicate directly (wired and/or wirelessly) with the main server 12, one or more of the local hub servers 22 and/or one or more of the POS systems 24. In some such embodiments, one or more of the wireless signal transceivers and/or receivers may include one or more conventional processors and one or more memory devices having instructions stored therein executable by the one or more processors to execute one or more of steps for determining an identity of an individual carrying a mobile communication device within and/or near a store.

In other alternate embodiments, one or more PIDs 222 may be implemented in the form of a combination of conventional Global Positioning System (GPS) satellites and a GPS receiver on-board a mobile communication device.

In other alternate embodiments, one or more PIDs 222 may be implemented in the form of one or more in-store WiFi Access Points which establish one or more in-store or store-wide hotspot having a unique internet access ID (HotSpotID) accessible by a mobile communication device. In such embodiments, the server 12 may determine a location of a mobile communication device in accordance with the unique internet access ID used by the mobile communication device to communicate with the mobile communication device.

In other alternate embodiments, one or more PIDs 222 may be implemented in the form of a combination of the earth's Geomagnetic Field and a magnetometer on-board a mobile communication device. In such embodiments, the server 12 may determine the location of a mobile communication device in accordance with the unique magnetic field signature captured by the magnetometer and wirelessly transmitted to the server 12 by the mobile communication device. In such embodiments, the server database may have one or more maps, tables, lists or the like mapping magnetic signature profiles within one or more of the stores to locations or positions within one or more of the stores, and the server 12 may be operable in such embodiments to determine the in-store location or position of a mobile communication device by comparing the unique magnetic field signature wirelessly transmitted by the mobile communication device to the stored magnetic signature profiles.

In other alternate embodiments, one or more of the PIDs 222 may be implemented in the form of a combination of a camera on-board a mobile communication device and a product label affixed to product or product location within a store. In such embodiments, the camera may be operated to capture an image of the product label and wirelessly transmit the image to the server. The server may then compare the image to stored product data to determine the in-store location thereof.

In other alternate embodiments, one or more of the PIDs 222 may be implemented in the form of a combination of a mobile communication device with a keypad and a customer/employee application operating on the mobile communication device. In such embodiments, the customer/employee application may display one or more manually selectable GUI elements for manually entering the location of the mobile communication device, and the mobile communication device may then wirelessly transmit the location information to the server.

In other alternate embodiments, one or more of the PIDs 222 may be implemented in the form of a wireless signal transmission device, e.g., RFID Tag, NFC device, etc., attached to customer-selected product. In such embodiments, the wireless signal transmission device may be configured to wirelessly transmit product information (e.g., brand, size, etc.) and/or location (e.g., department, aisle, shelf position, etc.) to a mobile communication device which then wirelessly transmits the information to the server.

In other alternate embodiments, one or more of the PIDs 222 may be implemented in the form of a combination of one or more in-store Cameras and a server-based facial and/or product recognition application. In some such embodiments, the server may process camera images and/or video and compare facial images with stored customer images to identify customers. In other embodiments, the server may process the camera images and/or video and compare product images, e.g., in customer's possession (basket, hand-carried, etc.) with stored product images, and then predict the customer's identity based on information contained in customer shopping histories.

In other alternate embodiments, one or more PIDs 222 may be implemented in the form of a combination of one or more electromagnetic radiation (EMR) generators positioned within a store and a mobile communication device with a camera and/or microphone. In such embodiments, the EMR may be generated in one or more spectral ranges, and be made to vary locally from store-to-store and throughout each store in one or more detectable EMR properties or characteristics, and/or EMR having different properties or characteristics may be generated in each store and in different areas of each store, such that in any case different stores, and different areas within each store, will be subject to different generated EMR properties or characteristics. The different EMR properties and/or characteristics generated in each store and in each area of each store may be stored in an EMR database, and local EMR properties/characteristics may be detected by a mobile communication device and wirelessly transmitted to the server which may then compare such received information to the EMR database to determine the location of the mobile communication device. Examples of such EMR generators and corresponding EMR detectors include, but are not limited to, one or more visible Light Generators and a camera on-board a mobile communication device, one or more audible frequency Generators and a microphone on-board a mobile communication device, one or more radio frequency generators and a radio frequency generator on board a mobile communication device, and the like.

In other alternate embodiments, one or more PIDs 222 may be implemented in the form of one or more mobile communication devices of one or more in-store customers or in-store employees. In such embodiments, in-store mobile communication devices may be configured to periodically broadcast signals detected by a customer's mobile communication device and/or transmitted directly to the server. Such broadcast signals be or include “location information” signals based on one or more “hard events” such as a recently received unique identification signal transmitted by an in-store wireless signal broadcasting device, a recently scanned or imaged product code, detected product device data, recently received GPS data, recently used HotSpotID data, recently detected EMR data, and/or the like. Alternatively or additionally, the one or more broadcast signals may be or include location information signals based on one or more “soft events” such as locally detected sounds (generated or not), locally detected light (generated or not), locally detected RF signals, and/or the like.

In any of the foregoing embodiments, information may be transmitted, receive and/or processed by any one or combination of any system or device disclosed herein.

What is claimed is:

1. A method of effecting payment for purchases at any of a plurality of point-of-sale systems of a retail enterprise, the method comprising:
associating, with a first processor in a first database, each of the plurality of point-of-sale systems with a different identification code,
associating, with the first processor in the first or a second database, a first code and an electronic payment system preauthorized by a customer member of the retail enterprise for automatic payment processing during purchase transactions carried out by the customer member at any of the plurality of point-of-sale systems,
in response to a wirelessly received identification code, identifying with the first processor the one of the plurality of point-of-sale systems associated in the first database with the identification code that matches the wirelessly received identification code, and
in response to a wirelessly received second code, automatically processing with the first processor payment for one or more items in a current purchase transaction at the identified one of the plurality of point-of-sale systems using the preauthorized electronic payment system if the wirelessly received second code matches the first code.

2. The method of claim 1 wherein the first code comprises one of a plurality of enterprise membership service identification codes stored in the first or second database that uniquely identifies a customer as one of a plurality of customer members of an enterprise membership service program associated with the retail enterprise.

3. The method of claim 2 wherein automatically processing payment comprises:
comparing the wirelessly received second code with the plurality of membership service identification codes,
if the second code matches the one of the plurality of membership identification codes, identifying the preauthorized electronic payment system associated with the one of the plurality of membership identification codes, and
automatically processing payment using the identified electronic payment system.

4. The method of claim 2 further comprising controlling, at least in part with the first processor, a payment interface associated with the identified one of the plurality of point-of-sale systems to communicate a request for payment instead of automatically processing payment if the second code does not match the one of the plurality of membership identification codes.

5. The method of claim 2 further comprising wirelessly receiving a third code,
wherein the first code further comprises a security code,
and wherein automatically processing payment comprises automatically processing payment using the preauthorized electronic payment system if the wirelessly received second code matches the security code and if the wirelessly received third code matches the one of the plurality of membership service identification codes.

6. The method of claim 1 further comprising associating, with the first processor in the first or second database, the first code and the preauthorized electronic payment system with one of a plurality of enterprise membership service identification codes stored in the first or second database that uniquely identifies a customer as one of a plurality of customer members of an enterprise membership service program associated with the retail enterprise.

7. The method of claim 6 wherein automatically processing payment comprises automatically processing payment using the preauthorized electronic payment system if the wirelessly received second code matches the first code and if a wirelessly received third code matches the one of the plurality of membership service identification codes.

8. The method of claim 6 further comprising wirelessly receiving a third code,
wherein the first code includes the one of the plurality of enterprise membership service identification codes and a security code,
and wherein automatically processing payment comprises automatically processing payment using the preauthorized electronic payment system if the wirelessly received second code matches the security code and if the wirelessly received third code matches the one of the plurality of membership service identification codes.

9. The method of claim 6 wherein automatically processing payment comprises:
comparing the wirelessly received third code with the plurality of membership service identification codes,
if the wirelessly received third code matches the one of the plurality of membership identification codes, identifying the first code associated with the one of the plurality of membership service identification codes and comparing the wirelessly received second code with the identified first code,
if the wirelessly received second code matches the identified first code, identifying the preauthorized electronic payment system associated with the one of the plurality of membership identification codes, and
automatically processing payment using the identified electronic payment system.

10. The method of claim 5 further comprising controlling, at least in part with the first processor, a payment interface associated with the identified one of the plurality of point-of-sale systems to communicate a request for payment instead of automatically processing payment if the second code does not match the security code or the third code does not match the one of the plurality of membership identification codes.

11. The method of claim 1 further comprising wirelessly transmitting the first and second codes with a mobile communication device under control of a second processor separate and remote from the first processor, the mobile communication device separate from the first processor and from each of the plurality of point-of-sale systems.

12. The method of claim 1 further comprising:
associating, with the first processor in the first or second database, the first code and a purchase history stored in the first or second database and associated with the customer member of the retail enterprise, and
in response to the wirelessly received second code, automatically storing, with the first processor, information about the one or more items in the current purchase transaction in the purchase history contained in the first or second database if the wirelessly received second code matches the first code.

13. The method of claim 2 further comprising:
associating, with a first processor in the first or second database, the one of the plurality of enterprise membership service identification codes that uniquely identifies the customer as one of the plurality of customer members of the enterprise membership program with one of a plurality of purchase histories contained in the first or second database, and
in response to the wirelessly received second code, automatically storing, with the first processor, information about the one or more items in the current purchase transaction in the one of the plurality of purchase histories contained in the first or second database that is associated with the one of the plurality of enterprise membership service identification codes if the wirelessly received second code matches the first code.

14. The method of claim 1 further comprising:
scanning, with a price scanner associated with the identified one of the point-of-sale systems, prices of the one or more items in the current purchase transaction, and
with the first processor and in response to the wirelessly received second code, automatically discounting from the scanned prices discount amounts of virtual discount coupons contained in the first or second database or in a third database that match corresponding ones of the one or more items in the current purchase transaction if the wirelessly received second code matches the first code.

15. The method of claim 1, further comprising:
associating, with the first processor in the first or second database, the first code and a clipped virtual coupon repository stored in the first or second database and associated with the customer member of the retail enterprise, the clipped virtual coupon repository containing virtual discount coupons selected for redemption by the customer member prior to the current purchase transaction,
scanning, with a price scanner associated with the identified one of the point-of-sale systems, prices of the one or more items in the current purchase transaction, and
with the first processor and in response to the wirelessly received second code, automatically discounting from the scanned prices discount amounts of virtual discount coupons contained in the clipped virtual coupon repository that match corresponding ones of the one or more items in the current purchase transaction if the wirelessly received second code does not match the first code.

16. The method of claim 1, further comprising:
associating, with a first processor in the first or second database, the one of the plurality of enterprise membership service identification codes that uniquely identifies the customer as one of the plurality of customer members of the enterprise membership program with one of a plurality of clipped virtual coupon repositories contained in the first or second database that contains virtual discount coupons selected for redemption by the customer prior to the current purchase transaction,
scanning, with a price scanner associated with the identified one of the point-of-sale systems, prices of the one or more items in the current purchase transaction, and
with the first processor and in response to the wirelessly received second code, automatically discounting from the scanned prices discount amounts of virtual discount coupons contained in the one of the plurality of clipped virtual coupon repositories that is associated with the one of the plurality of enterprise membership service identification codes that match corresponding ones of the one or more items in the current purchase transaction if the wirelessly received second code does not match the first code.

17. The method of claim 1 further comprising:
associating, with the first processor in the first or second database, the first code and a credit repository stored in the first or second database and associated with the customer member of the retail enterprise,
scanning, with a price scanner associated with the identified one of the point-of-sale systems, prices of the one or more items in the current purchase transaction, and
with the first processor and in response to the wirelessly received second code, automatically discounting from the scanned prices of one or more of the one or more items in the current purchase transaction at least one credit amount contained in the credit repository if the wirelessly received second code matches the first code.

18. A system for effecting payment for purchases at a retail enterprise, the system comprising:
a plurality of point-of-sale systems,
a plurality of wireless signal broadcasting devices each located at or near a different one of the plurality of point-of-sale systems,
at least one database having stored therein a plurality of identification codes each associated with a different one of the plurality of wireless signal broadcasting devices and also with a corresponding one of the plurality of point-of-sale systems at or near which each different wireless signal broadcasting device is located, and a plurality of passcodes each associated with a different one of a plurality of customer members of an enterprise membership service program associated with the retail enterprise and each also associated with a different electronic payment system preauthorized by a corresponding one of the plurality of customer members for automatic payment processing during purchase transactions carried out by the customer member at any of the plurality of point-of-sale systems,
a processor, and
memory having instructions stored therein which, when executed by the processor, cause the processor to identify, in response to a wirelessly received identification code, the one of the plurality of point-of-sale systems associated in the at least one database with the identification code that matches the wirelessly received identification code, and to automatically process, in response to a wirelessly received passcode, payment for one or more items in a current purchase transaction at the identified one of the plurality of point-of-sale systems using the preauthorized electronic payment system associated in the at least one database with the one of the plurality of passcodes that matches the wirelessly received passcode.

19. The system of claim 18 wherein the plurality of wireless signal broadcasting devices includes at least one radio frequency wireless signal broadcasting device.

20. A non-transitory machine-readable medium comprising a plurality of instructions which, when executed by at least one processor, result in the at least one processor:
associating in a first database each of the plurality of point-of-sale systems with a different identification code,
associating in the first or a second database a first code and an electronic payment system preauthorized by a customer member of the retail enterprise for automatic payment processing during purchase transactions carried out by the customer member at any of the plurality of point-of-sale systems,
in response to a wirelessly received identification code, identifying with the first processor the one of the plurality of point-of-sale systems associated in the first database with the identification code that matches the wirelessly received identification code, and
in response to a wirelessly received second code, automatically processing with the first processor payment for items in a current purchase transaction at the identified one of the plurality of point-of-sale systems using the preauthorized electronic payment system if the wirelessly received second code matches the first code.
